(19) United States
(12) Patent Application Publication
(10) Pub. No.: US 2018/0053160 A1
(43) Pub. Date: Feb. 22, 2018

(54) Wire Management and Tracking System

(71) Applicants: Joel E. Schwartz, Encino, CA (US); Dennis W. Fried, Encino, CA (US); Evan W. Carlsen, Valencia, CA (US)

(72) Inventors: Joel E. Schwartz, Encino, CA (US); Dennis W. Fried, Encino, CA (US); Evan W. Carlsen, Valencia, CA (US)

(21) Appl. No.: 15/683,729

(22) Filed: Aug. 22, 2017

Related U.S. Application Data
(60) Provisional application No. 62/536,131, filed on Jul. 24, 2017.
(60) Provisional application No. 62/377,994, filed on Aug. 22, 2016.

(51) Int. Cl. G06Q 20/10; G06Q 20/40

(52) U.S. Cl. CPC G06Q 20/10; G06Q 20/4014

(57) ABSTRACT

A management and tracking system supervises the transfer of funds when: (1) the sending institution originates the funds transfer; or (2) the receiving institution initiates the funds transfer. Tracking numbers are created and associated with details related to specific wire transfers from a sender to a receiver where wire processing institutions along the routing of the funds can track the transfer of funds process and easily identify problems or potential fraud thus enhancing the capabilities of management of the transfer of funds from one institution to another when a plurality of intermediate institutions may be involved in the funds transfer. The tracking number is created and applied to the transaction at the time of origination of the wire. Database entries are created to link the wire payment's location and/or status history within the group or set of institutions processing the particular wire payment.

### CLAIM OF PRIORITY

This application claims priority to U.S. Provisional Patent Application No. 62/536,131 filed on Jul. 24, 2017 titled “System and Method for Unique Wire Payment Tracking and Management” and U.S. Provisional Patent Application No. 62/377,994 filed on Aug. 22, 2016, titled “System and Method for Unique Wire Payment Tracking and Management” both of which are incorporated by reference in their entirety.

### BACKGROUND OF THE INVENTION

### 1. Field of the Invention

This invention provides a wire payment management and tracking system for use by financial institutions to transfer funds between a first location and a second location. Specifically, this invention creates a management and tracking system that supervises the transfer of funds when: (1) the sending institution originates the funds transfer; or (2) the receiving institution initiates the funds transfer.

### 2. Related Art

Wire payments have historically been used for transferring money quickly from one financial institution to another financial institution. Wire transfers have become a relatively easy methodology for transferring funds as the process is fast, while still maintaining chargeback capability in limited situation such as if mistakes are made or if fraud arises in the funds transfer. Improving the processing speed of wire transfers of funds with the advent of allowing customers to use online access of a financial account to initiate wire transfers has decreased the time needed to initiate a wire transfer and decrease data entry mistakes. Unfortunately, the gains in customer ease have been offset by an increase in fraud.

Current wire transfer systems have severe limitations on the ability to determine what stage the wire transfer is in during the actual transfer. This is lack of trackability is exacerbated by the complex path funds often take while traveling through multiple intermediate or beneficiary financial institutions from their account of origin to the destination account. Locating the funds when problems arise during this multiple stage process often takes days or weeks due to the difficulties in first finding the funds and then getting them returned to the sending account or routed to the correct destination account. If incorrect account numbers or routing numbers are associated with the wire transfer process, unraveling the transaction can take upwards of one (1) to three (3) months in order to determine where the funds are stalled or are being held as an investigation into the wire transfer requires a time consuming manual review and research into transaction logs that may have tens of thousands of transactions on a given day.

The Society for Worldwide Interbank Financial Telecommunication (“SWIFT”), attempted to solve this issue decades ago by creating a messaging system where messages could be sent from the sending financial institution to requesting funds confirmation from the receiving financial institution or to requesting research on a specific wire transfer payment. However, utilization of the SWIFT system is limited by technological limits such as hardware and software restrictions since the technology is based on a system designed decades ago. Under the SWIFT system, the receiving party to a financial transaction and the associated financial institution often know nothing about the incoming wire payment until the funds arrive or are past due.

Another shortcoming of current wire payment systems are the limitations in providing analytic data on the wire payment process. Numerous issues arise as institutions are unable to gather analytic information regarding the efficiency of the wire transfer process. These shortcomings can include: (1) validating receiver information; (2) providing remittance information; (3) measuring the time required to create and input wire payment instructions by the customer; and (4) measuring the efficiency or time during each stage spent by the funds in the funds transfer process. Currently, the wire transfer process of funds does not track or validate the receiver information (e.g., name, address, financial institution account number validation of the receiving institution's routing number and invalid intermediate institution's routing number). Other limitations include verification of the funds prior to the initiation of the wire transfer process. Financial institutions have typically implemented a method of storing receiver information in their systems to assist customers who make repeated wire payments to the same party. Nevertheless, there is no mechanism for a financial institution to validate the receiver information with the receiving financial institution prior to initiation of the wire. Yet this limitation often leads to rejected funds transfer payments or in the alternative leads to unproductive, time consuming funds transfer research requests.

Without remittance information, senders of funds and receivers of those funds spend significant amounts of time verifying particular wire payments and associating those payment to specific transactions, purchase orders or invoices for the purchase of particular goods and/or services. Typically, the fund's receiver has to initiate a research process for each wire payment by verifying the sending party's name, address, and payment information so that credits can be made to the sending party's account. Additional complications arise when the sender transmits an amount that is more than or less than the receiving party's request, purchase order amount or invoice amount.

Additional problems arise when wire payment details are sent through unsecure transmission channels that are vulnerable to improper data collection, altering of information, and tampering, thus leaving the senders and their related financial institutions exposed to fraudulent practices by unscrupulous third parties.

Shortcomings in current systems exist related to limitations on the ability of a funds sender to stop a wire payment once the wire process is initiated. Few, and in many instances, no agreements exist between financial institutions for recalling a wire payment when the wire is in transit. Getting a wire payment reversed is in many cases nearly impossible. When the wire payment is reversed, it typically involves a time-consuming process utilizing numerous institutions and their employees and can take one (1) to three (3) months to complete. If the wired funds are substantial amount, this one (1) to three (3) month delay could put business transactions, construction projects, loan payments, customer relationships at risk, and even imperil the receiving party's ability to stay in business. Additional risks also may include requirements for indemnification from the requesting financial institution when a wire is recalled.

Another shortcoming of existing funds transfer systems is the inability for the sender of the funds to receive confirmation that the receiver actually timely received the funds. Senders of wires lack a vital benefit currently achieved by cancelled checks; namely knowledge that the receiver has successfully received the wire transfer without the need to independently contact the receiver and obtain confirmation that the funds arrived.

A need exists for a funds transfer system that provides great transparency, analytics for proactively identifying road blocks or interruptions/slowdowns during the funds transfer process; implementing an analytics system for proactively diagnosing service interruptions or slowdowns, an acknowledgement system providing feedback on the status of the funds during the funds transfer process, and methodologies for reducing fraud in the wire payment process.

### SUMMARY

The Wire Management and Tracking (“WMT”) system (WMT) provides solutions to problems associated with wire transfer payments, namely a real-time tracking of the wire transfer as it moves through various financial institutions. The WMT system allows all parties involved in the wire transfer of money (sender, receiver, sending institution, receiving institution, and transmitting institution (i.e. intermediary/corresponding institution)) to know accurately where the wire payment is currently being processed and where it has already been processed. The WMT system may use industry standard data from SWIFT to calculate the path (“flight paths”) for the wire transfer ahead of formulating a global tracking ID that ties the various institutions tracking information together. The WMT system can be implemented using a cloud-based system, also known as a cloud-based API that connects with financial institutions systems.

The WMT system is designed to simplify and expedite the creation of a wire transfer. One way the platform simplifies the process is by allowing the receiver of the wired funds to provide their information to the sender via alphanumeric codes generated by the WMT system prior to the sending of the wire in order to ensure that the wire's flight path is correct. Conversely, the sender of a wire transfer of funds can quickly set up a wire transfer using the same alphanumeric codes generated by the WMT system.

Wire payments are set up within the WMT system using a set of at least three codes: primary codes, party codes, and express codes. The primary code is an alphanumeric code that is generated using the customer ID of a sending or receiving financial institution. The WMT system, through integrating with a financial institutions internal system, can generate this code to identify an individual(s) associated within the financial institution. The party code contains the primary code plus an additional alphanumeric sequence that corresponds with the following data fields: name, address, phone, email, financial institution name, routing number and account number. The party code can be stored on the sending financial institution's wire recipients list for a specific consumer/business and can be reused to set up multiple wire payments. The express code comprises the party code plus an additional alphanumeric sequence that corresponds to specific transaction details including the following data fields: amount of funds being wired, the currency, remittance information, and specific contact details of the sender and receiver. Once the express code is used to initiate a wire payment, the WMT system creates a unique tracking ID that associates with the express code and is stored within the WMT system. The party code or express code provides account details that allow the sending financial institution to verify the information via the cloud-based API. In addition, either the party code or express code verification can include a secondary method to validate the sender's request via such mechanisms as PIN codes, biometric or any other secure methods that functions as a “second key” validation method.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

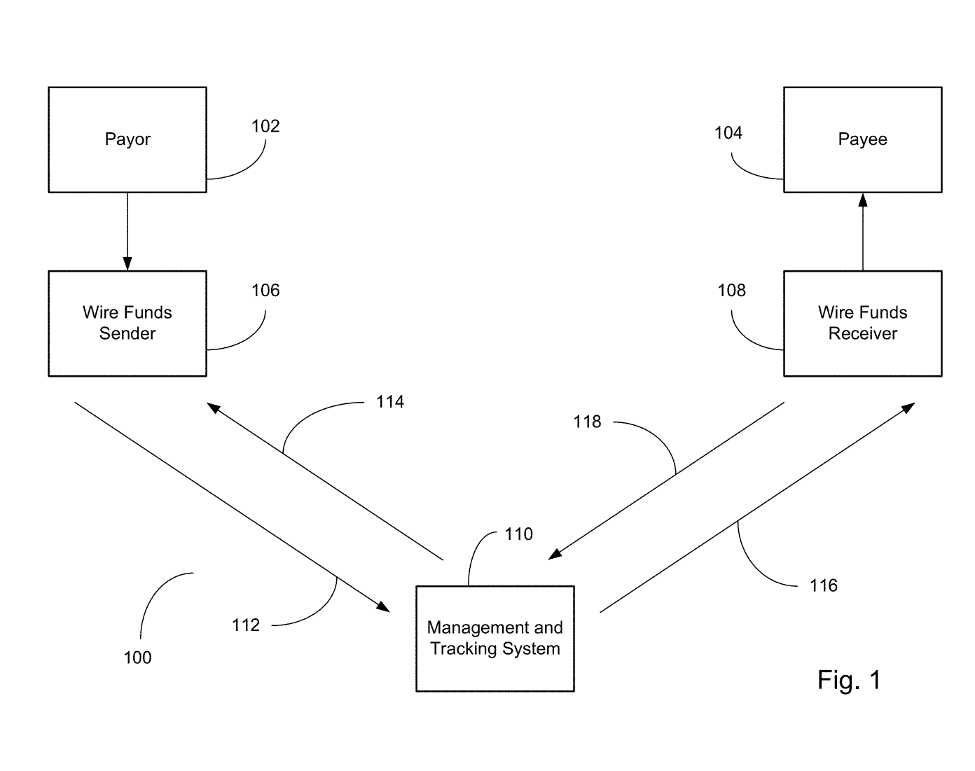

FIG. 1 is a block diagram illustrating an overview of a wire transfer tracking and management system from the prospective of a sender wiring funds to a receiver and using a wire management and tracking system.

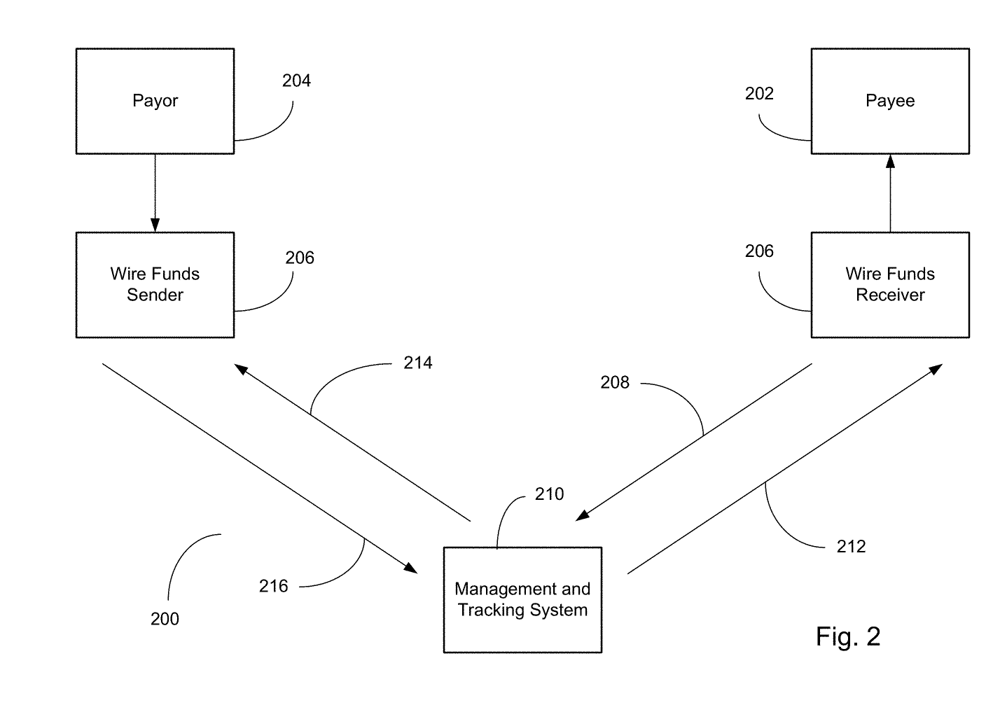

FIG. 2 is a block diagram illustrating an overview of a wire transfer tracking and management system from the prospective of a receiver requesting a sender to wire funds to the receiver and using a wire management and tracking system.

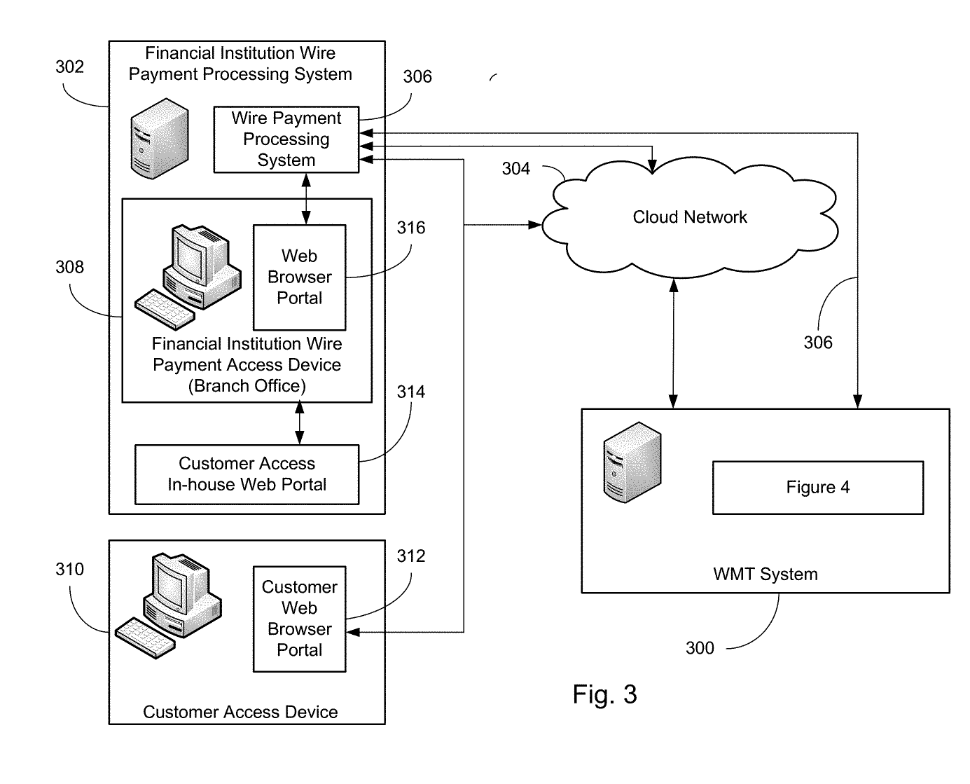

FIG. 3 is a block diagram illustrating the hardware and networking components of a funds transfer system using a wire management and tracking system.

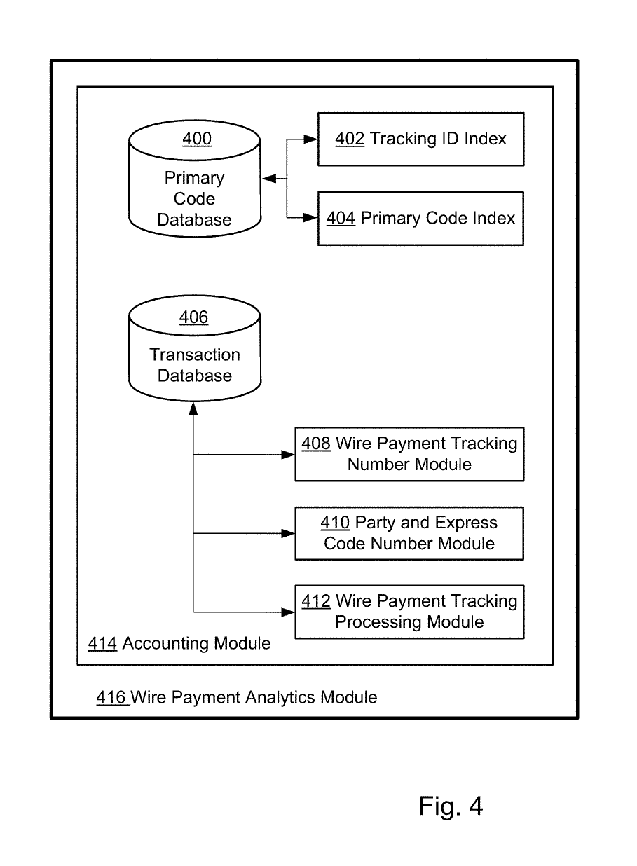

FIG. 4 is a block diagram illustrating the software components of the WMT system for wire payments with the implementation of at least one database and at least one software module.

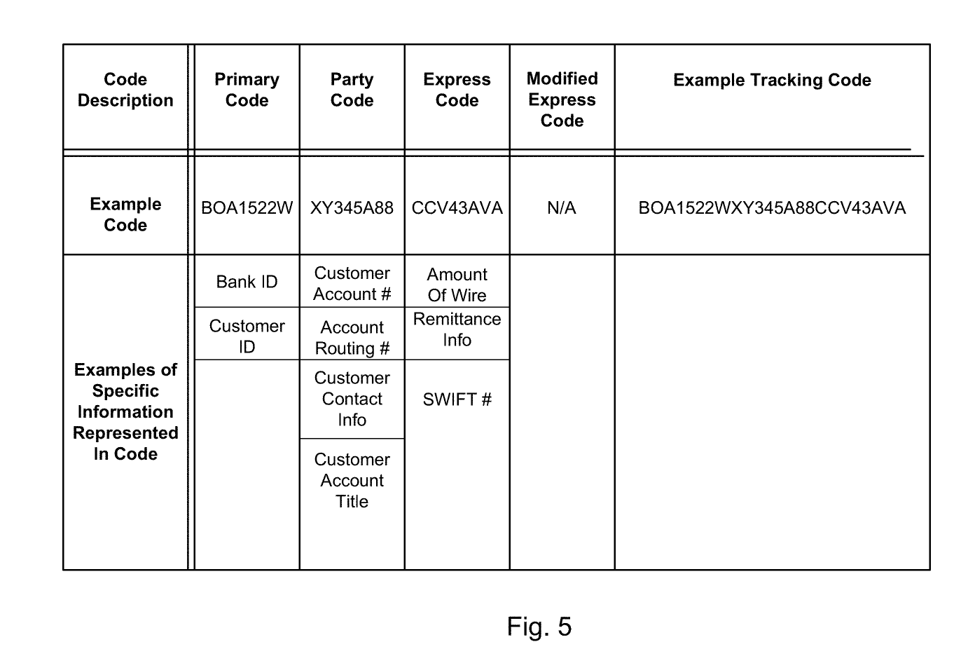

FIG. 5 is a table illustrating the primary code, party code, express code used in a wire management and tracking system.

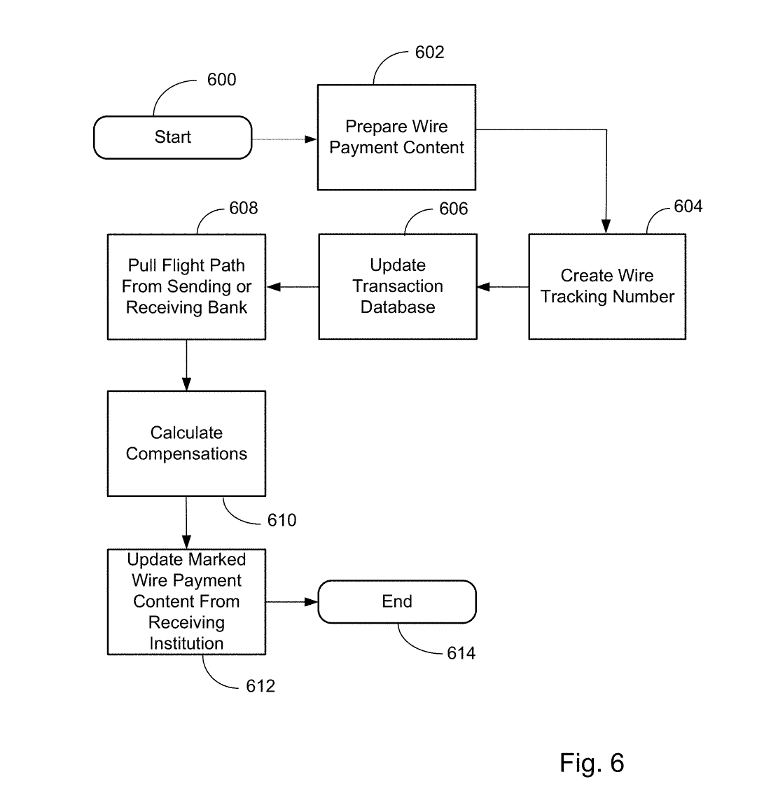

FIG. 6 is a flow chart illustrating the process for creating the tracking numbers and calculating compensations from the flight paths with the WMT system.

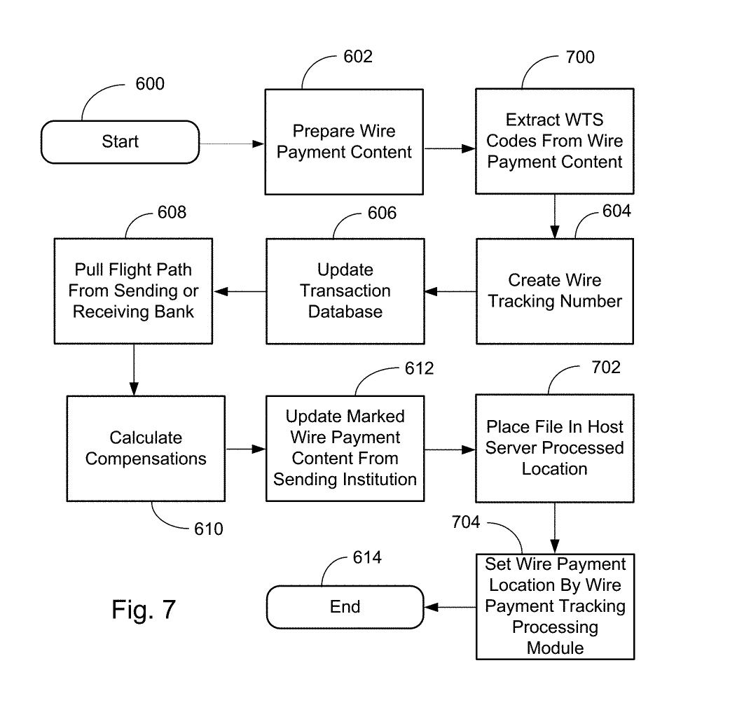

FIG. 7 is a flow chart illustrating an alternative embodiment process for creating tracking numbers and calculating compensations from the flight paths with the WMT system.

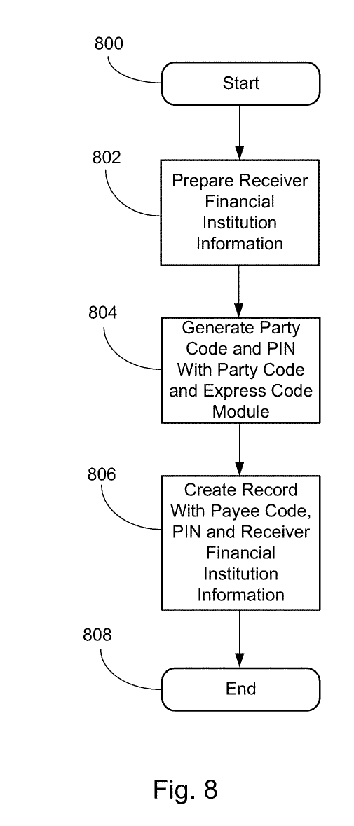

FIG. 8 is a flow chart illustrating the creation of party codes by the WMT system.

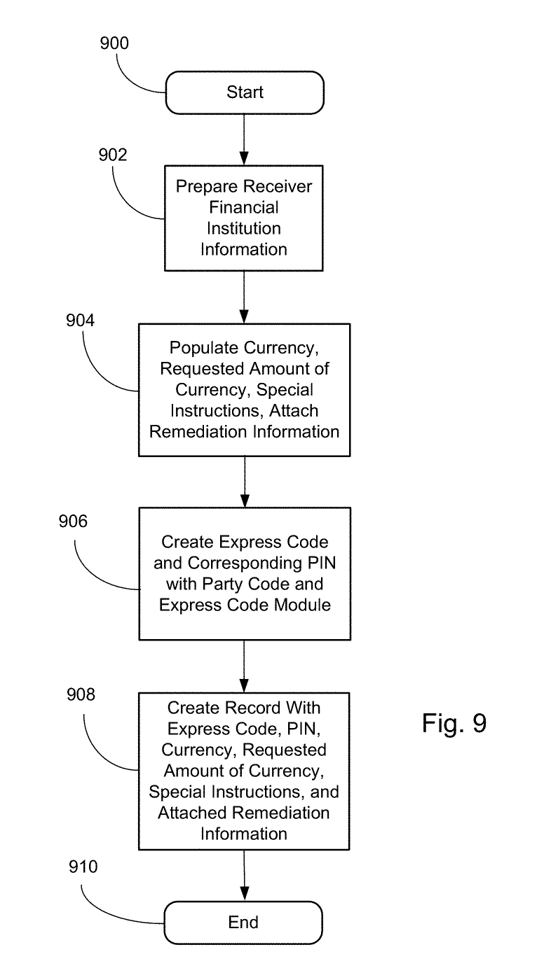

FIG. 9 is a flow chart illustrating the creation of express codes by the WMT system.

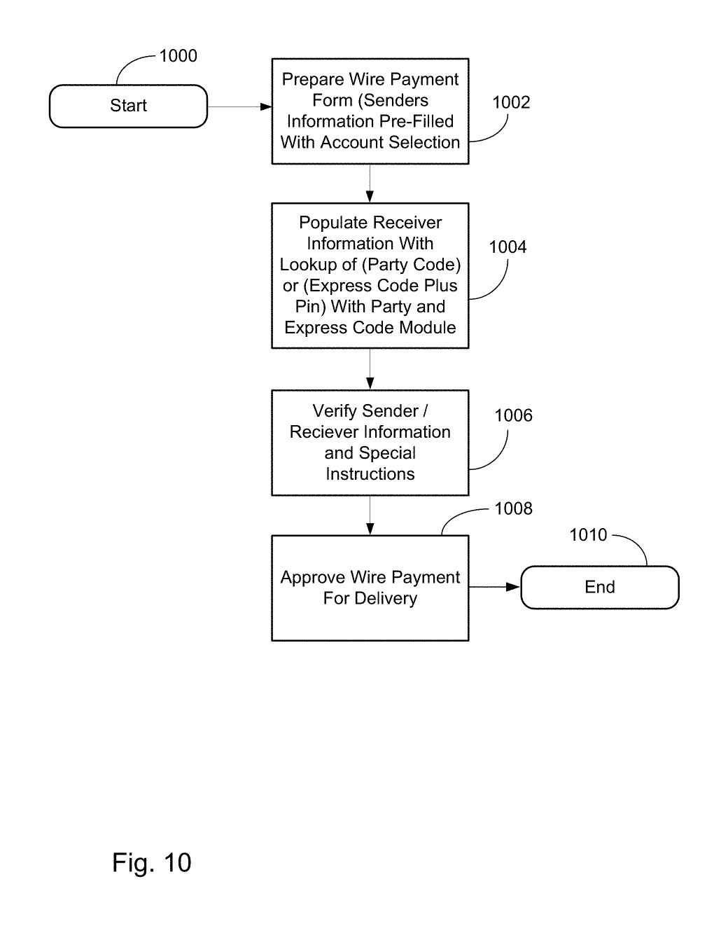

FIG. 10 is a flow chart illustrating the process for creating party codes and express codes by the WMT system.

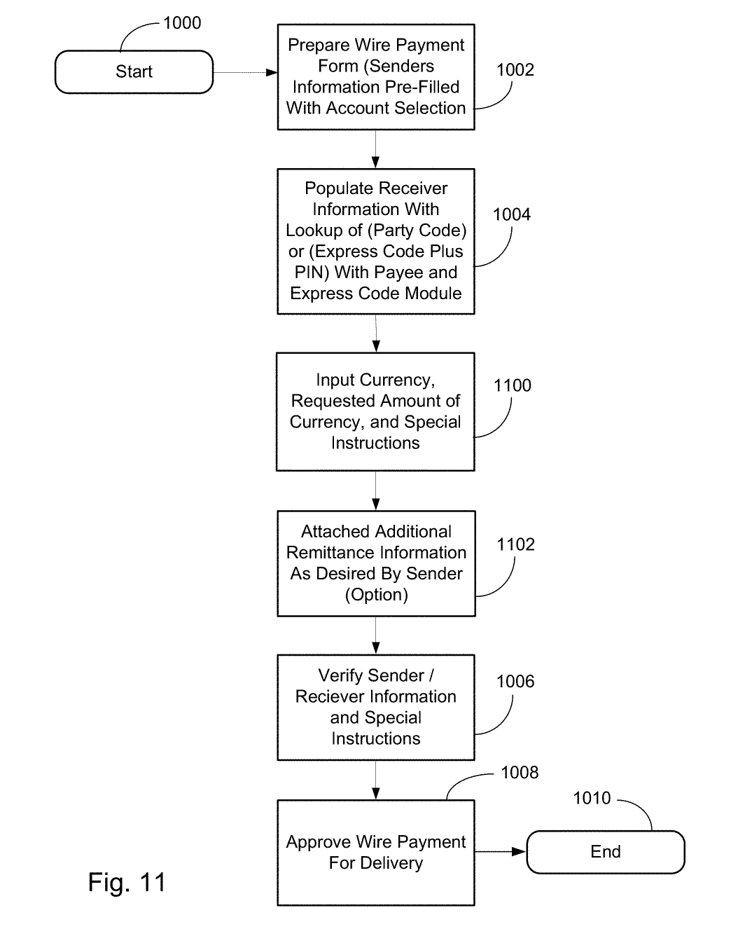

FIG. 11 is a flow chart illustrating an alternative embodiment of the process for creating party codes and express codes by the WMT system.

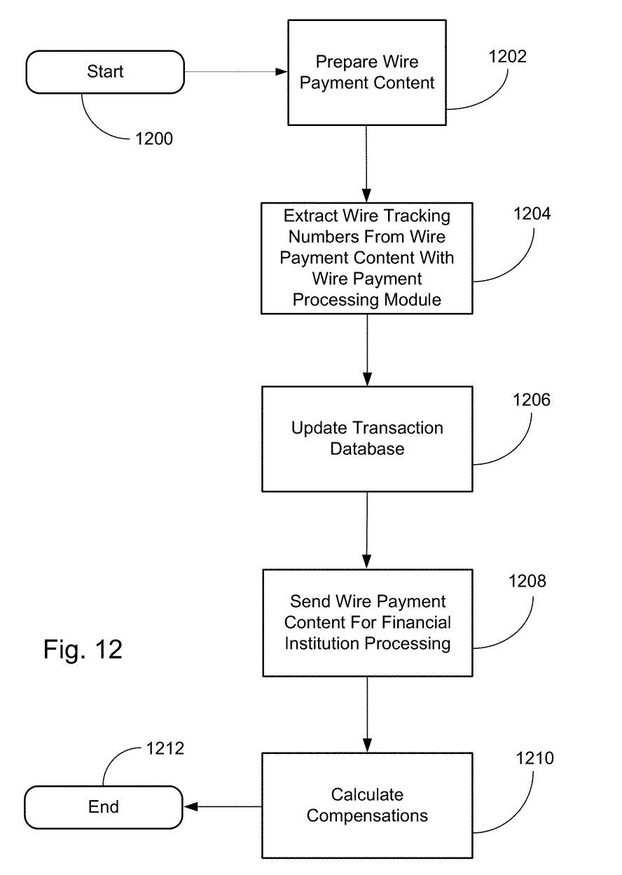

FIG. 12 is a flow chart illustrating the process for extracting wire fund payments by the WMT system.

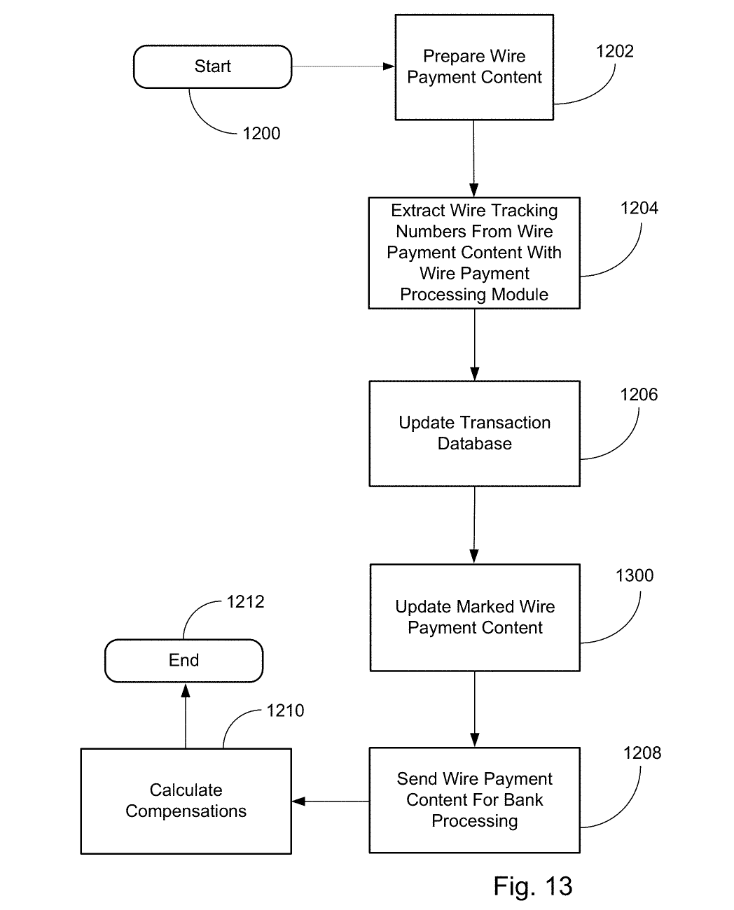

FIG. 13 is a flow chart illustrating an alternative embodiment of the process for extracting wire fund payments by the WMT system.

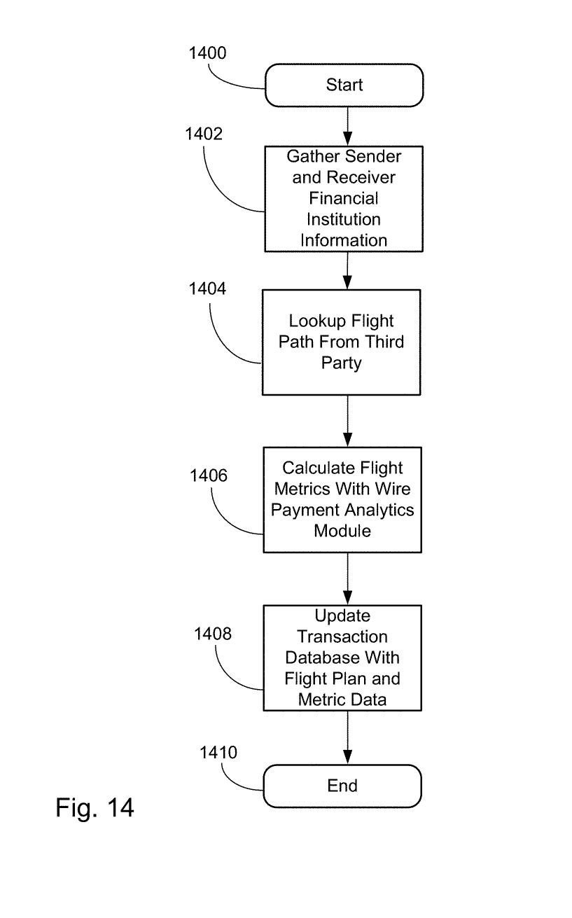

FIG. 14 is a flow chart illustrating an alternative embodiment of the process for tracking wire fund payments by the WMT system.

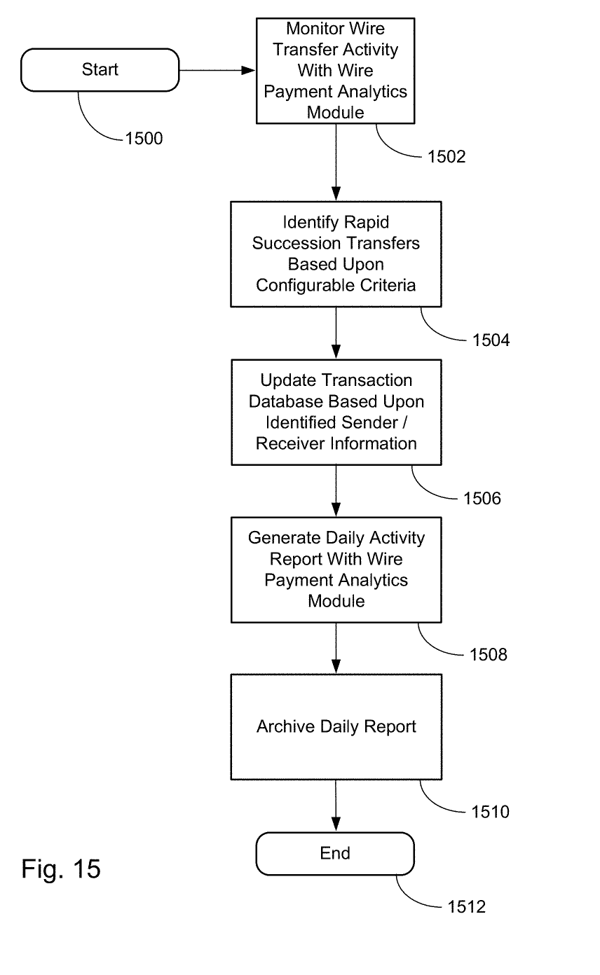

FIG. 15 is a flow chart illustrating the process for performing wire payment analytics by the WMT system.

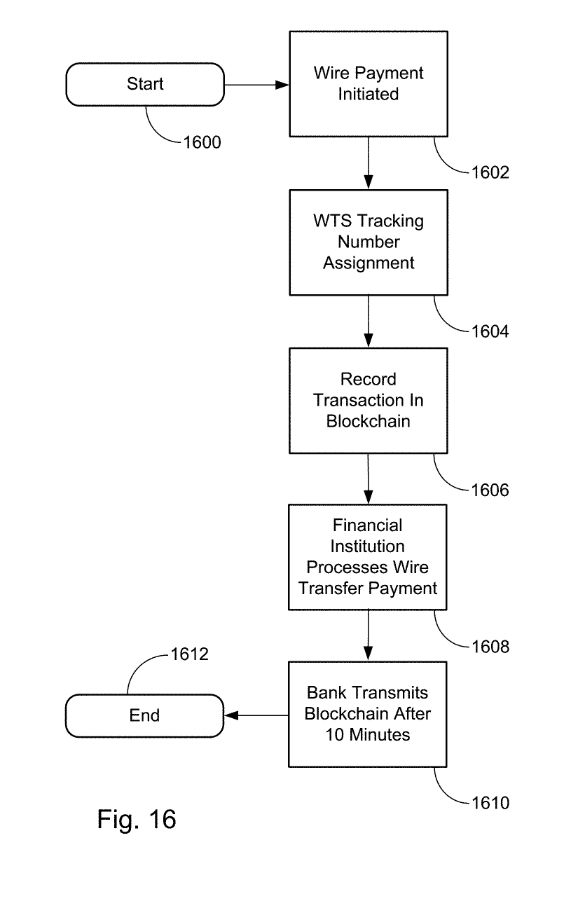

FIG. 16 is a flow chart illustrating the process for using a blockchain ledger to record a transaction performing wire payment analytics by the WMT system.

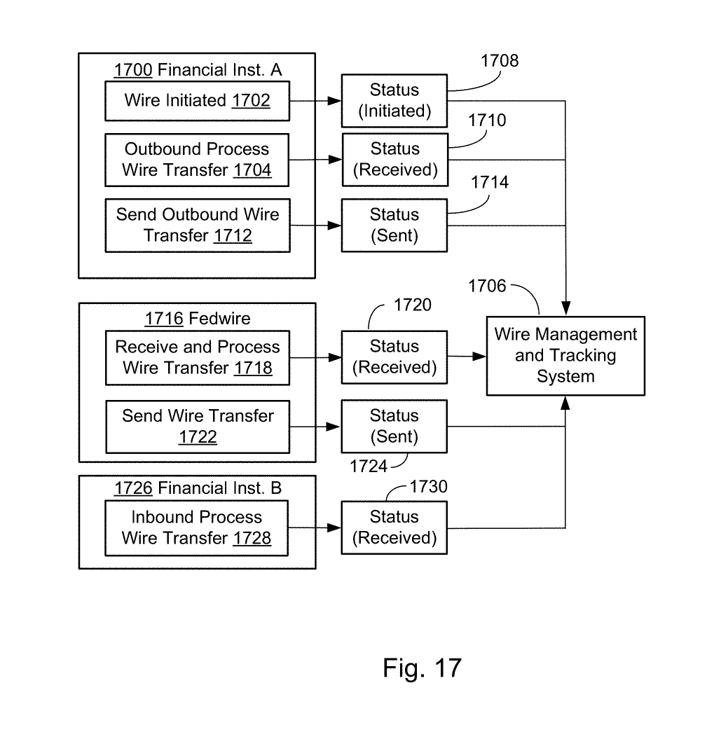

FIG. 17 is a block diagram illustrating a wire of funds in the United Stated using Fedwire and interactions with the wire management and tracking system.

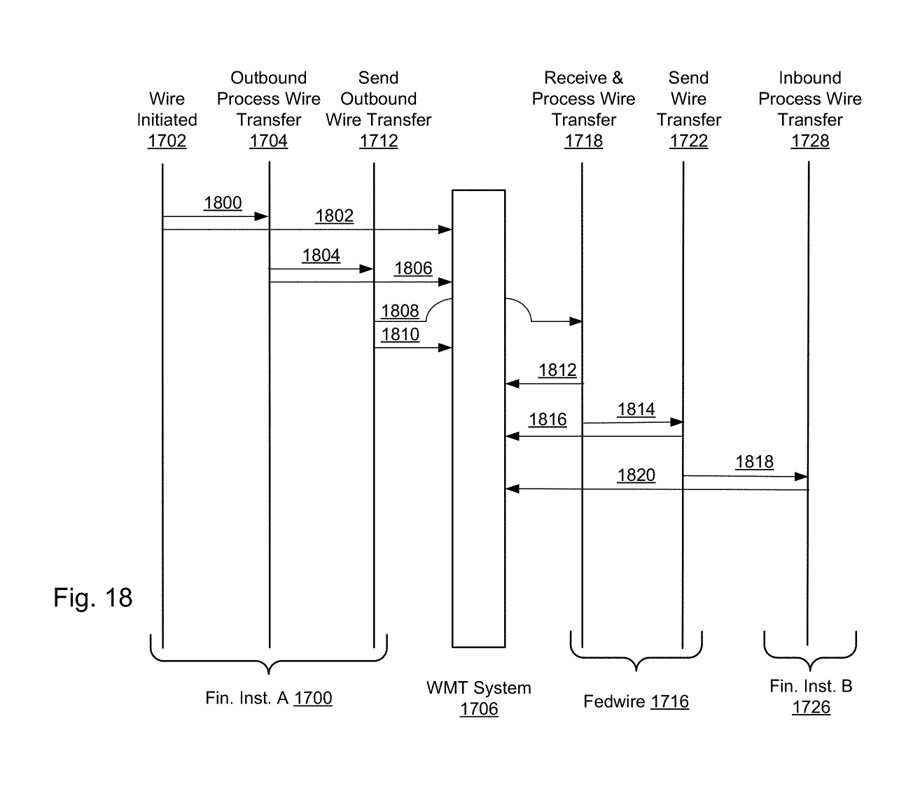

FIG. 18 is a signal path diagram that illustrates the message flow according to the wiring of funds illustrated in FIG. 17.

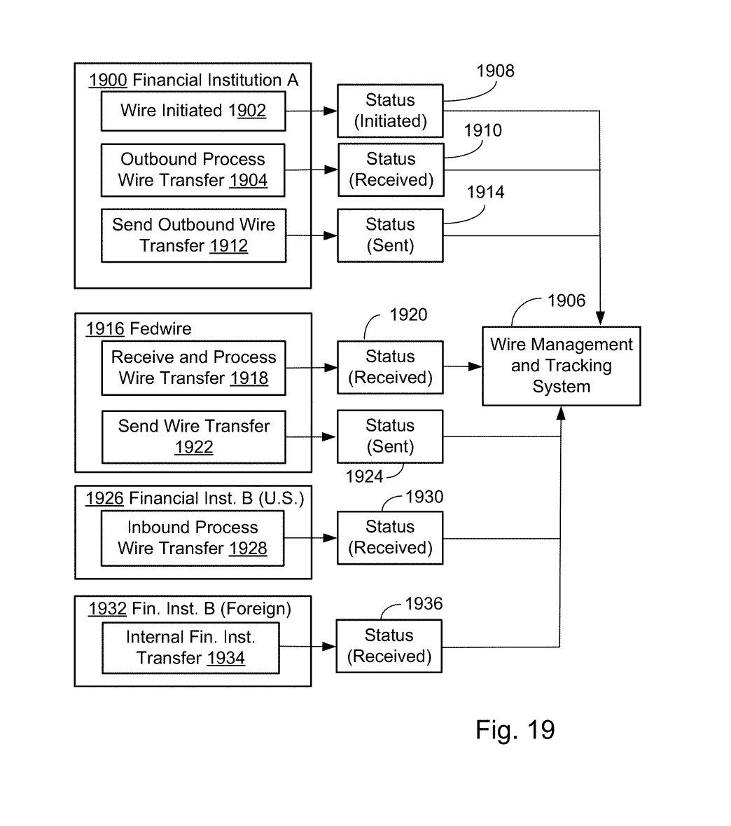

FIG. 19 is a block diagram that illustrates the messages sent using a wire management and tracking system during the transmission of a wire payment to another country's financial institution using Fedwire and a United States beneficiary financial institution prior to sending the funds to a foreign country's financial institution.

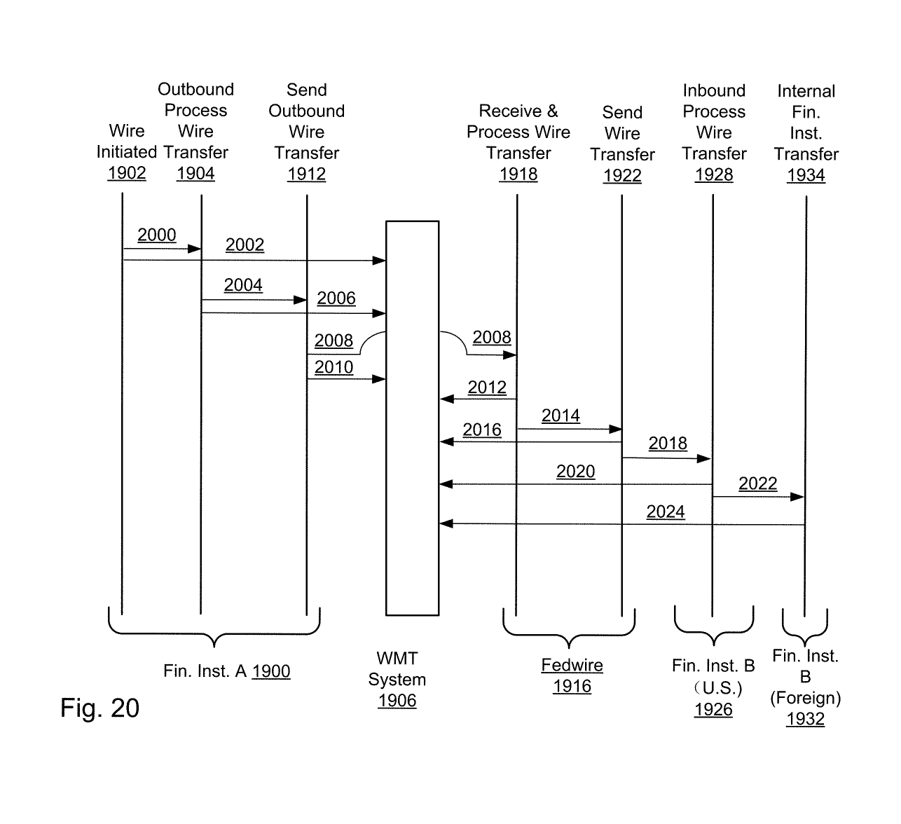

FIG. 20 is a signal path diagram that illustrates the message flow according to the wiring of funds illustrated in FIG. 19.

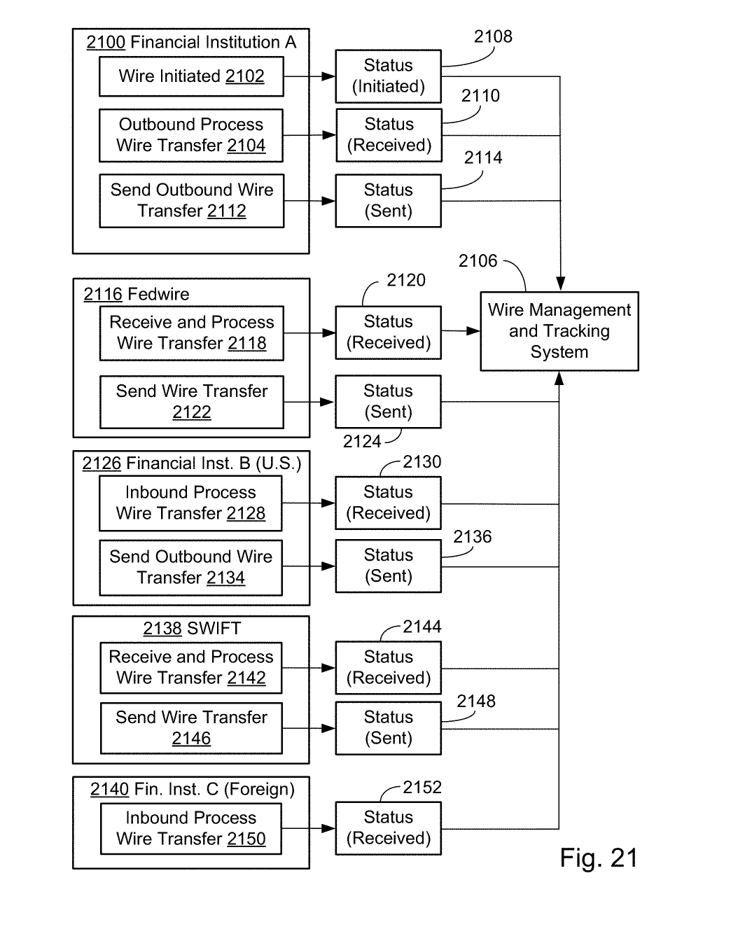

FIG. 21 is a block diagram that illustrates the messages sent using a wire management and tracking system during the transmission of a wire payment to another country's financial institution using Fedwire to route the funds to a United States beneficiary financial institution and SWIFT to route the funds to a foreign country's financial institution.

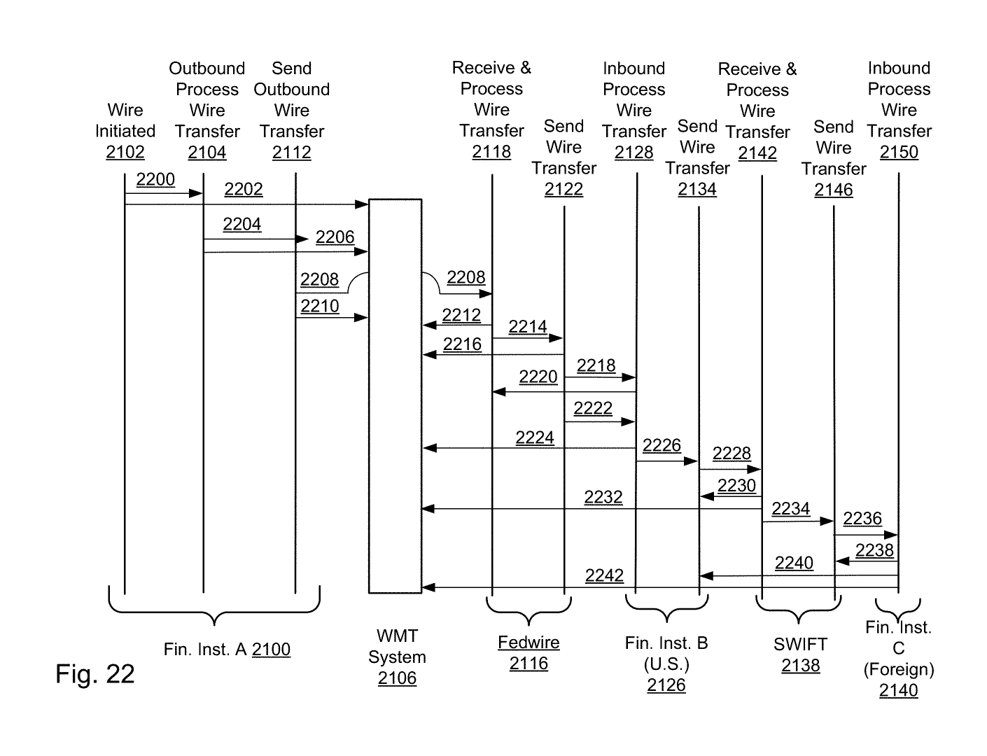

FIG. 22 is a signal path diagram that illustrates the message flow according to the wiring of funds illustrated in FIG. 21.

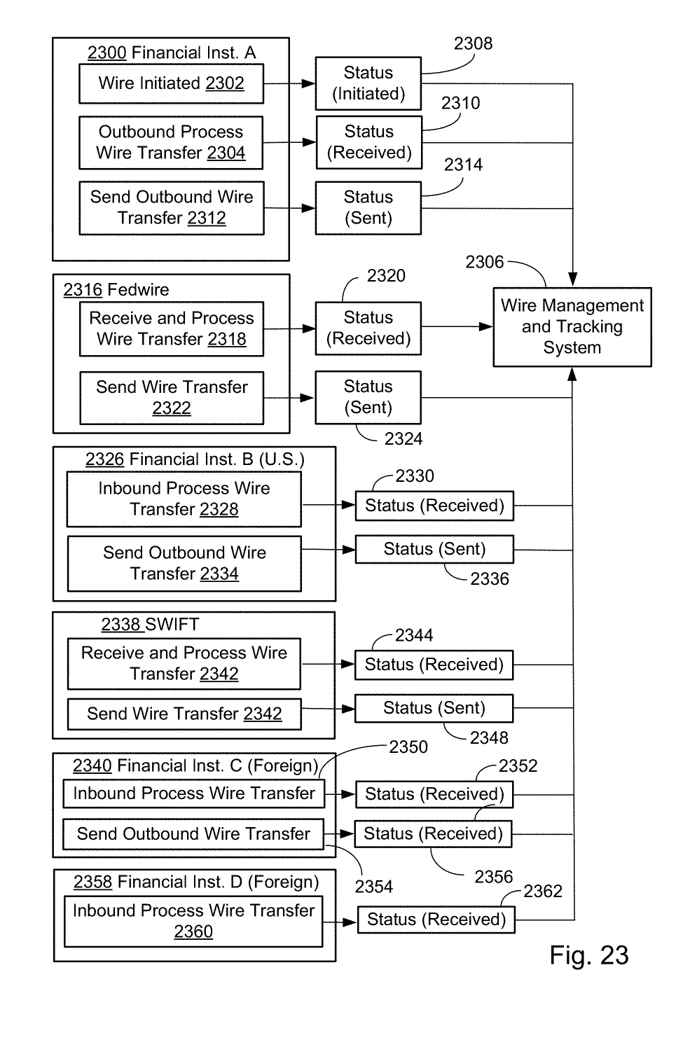

FIG. 23 is a block diagram that illustrates the messages sent using a wire management and tracking system during the transmission of a wire payment to another country's financial institution using Fedwire to route the funds to a United States beneficiary financial institution and SWIFT to route the funds to a first foreign country's financial institution and then to a second financial institution in that foreign country.

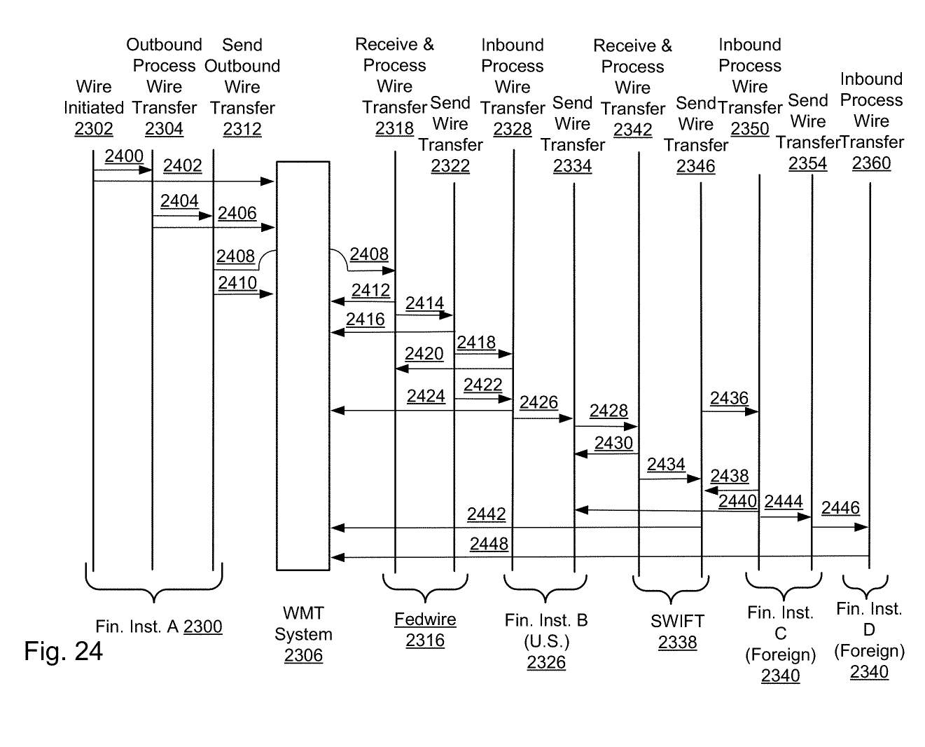

FIG. 24 is a signal path diagram that illustrates the message flow according to the wiring of funds illustrated in FIG. 23.

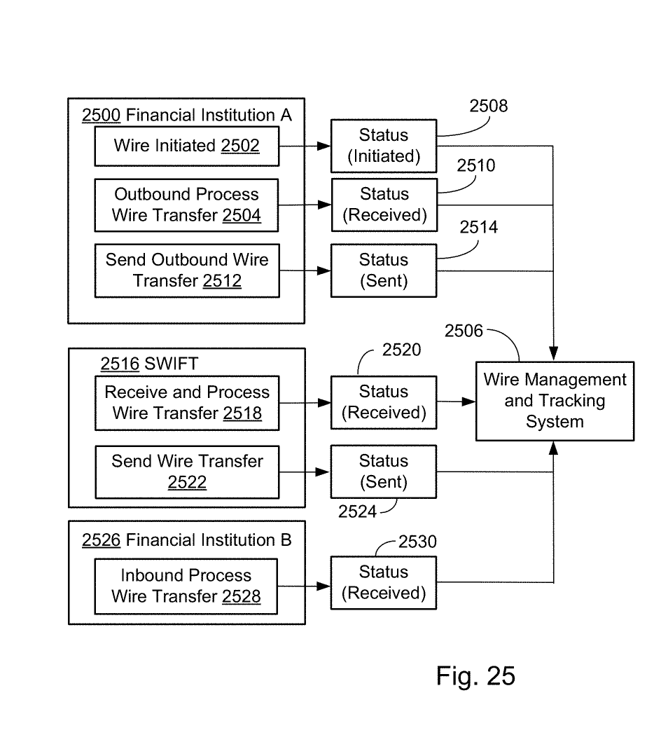

FIG. 25 is a block diagram that illustrates the messages sent using a wire management and tracking system during the transmission of a wire payment from a first financial institution to a second financial institution via SWIFT.

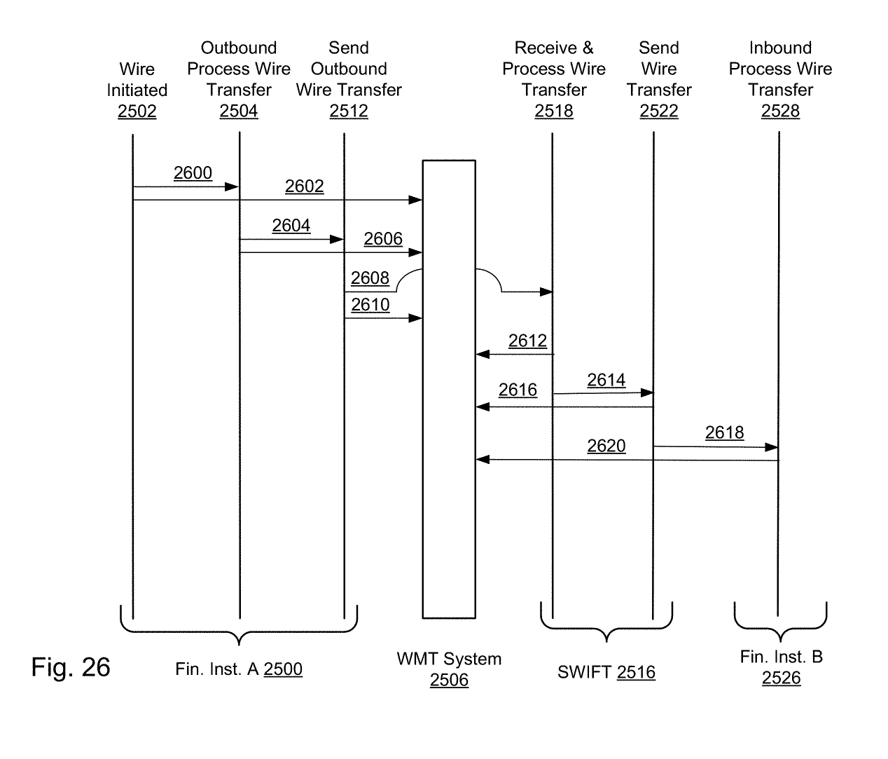

FIG. 26 is a signal path diagram that illustrates the message flow according to the wiring of funds illustrated in FIG. 25.

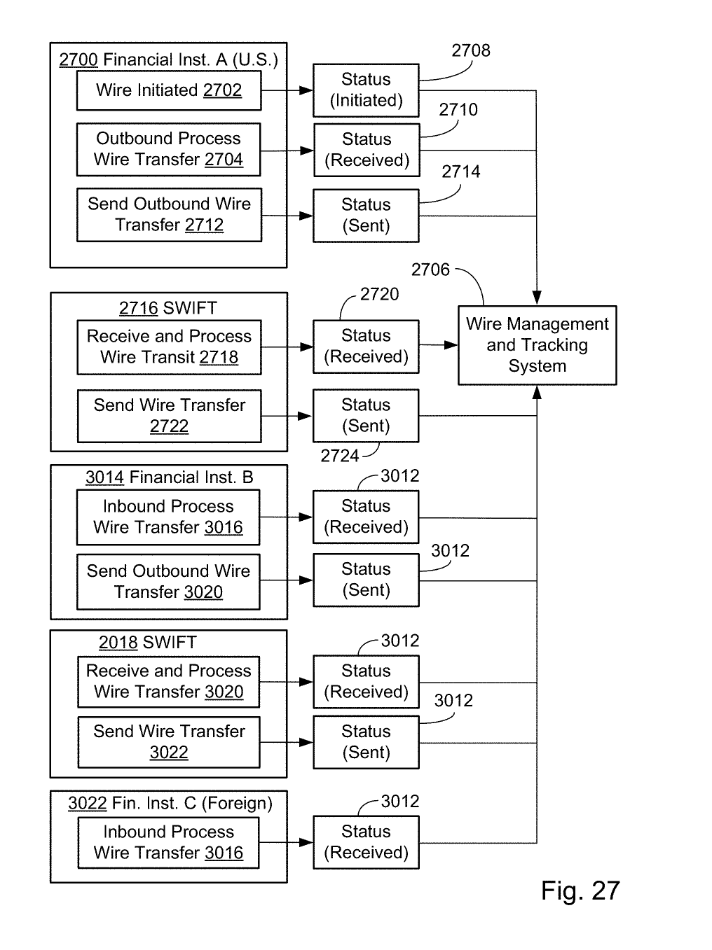

FIG. 27 is a block diagram that illustrates the messages sent using a wire management and tracking system during the transmission of a wire payment from a first financial institution to a second financial institution via SWIFT and onwards to a third financial institution via SWIFT.

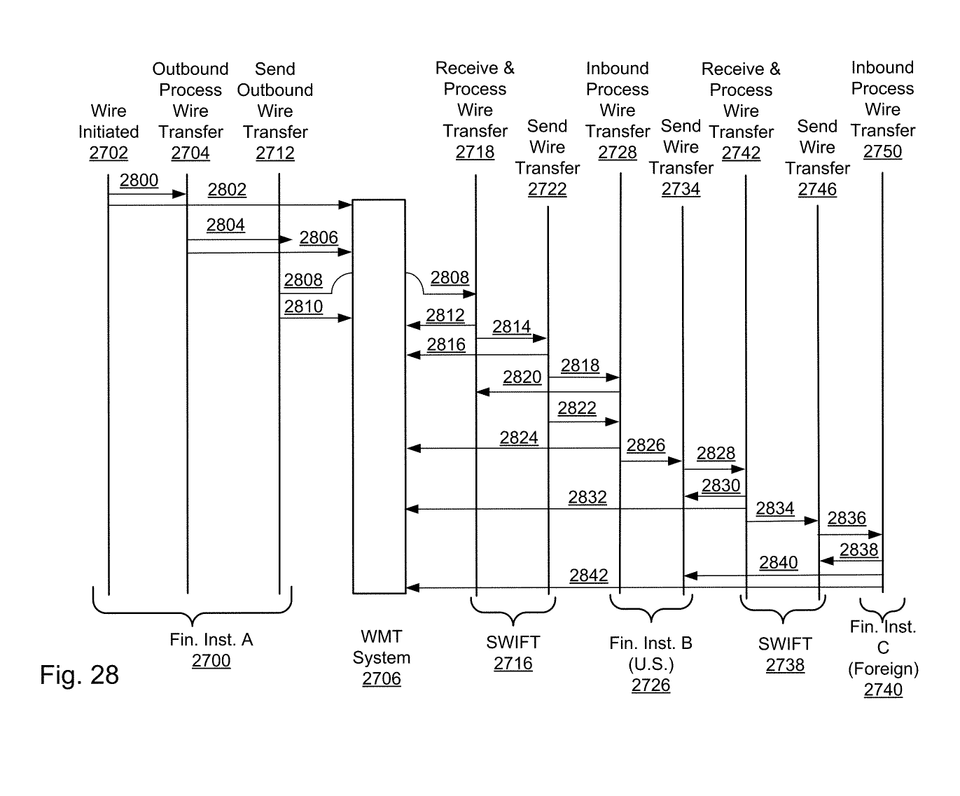

FIG. 28 is a signal path diagram that illustrates the message flow according to the wiring of funds illustrated in FIG. 27.

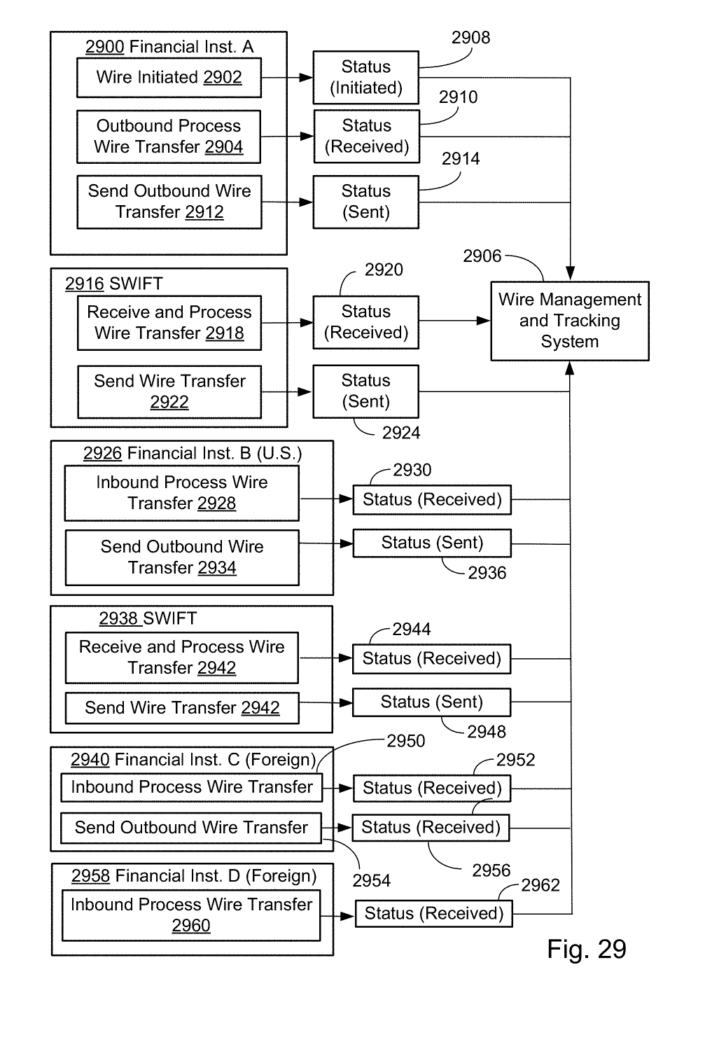

FIG. 29 is a block diagram that illustrates the messages sent using a wire management and tracking system during the transmission of a wire payment from a first financial institution to a second financial institution via SWIFT and onwards to a third financial institution via SWIFT.

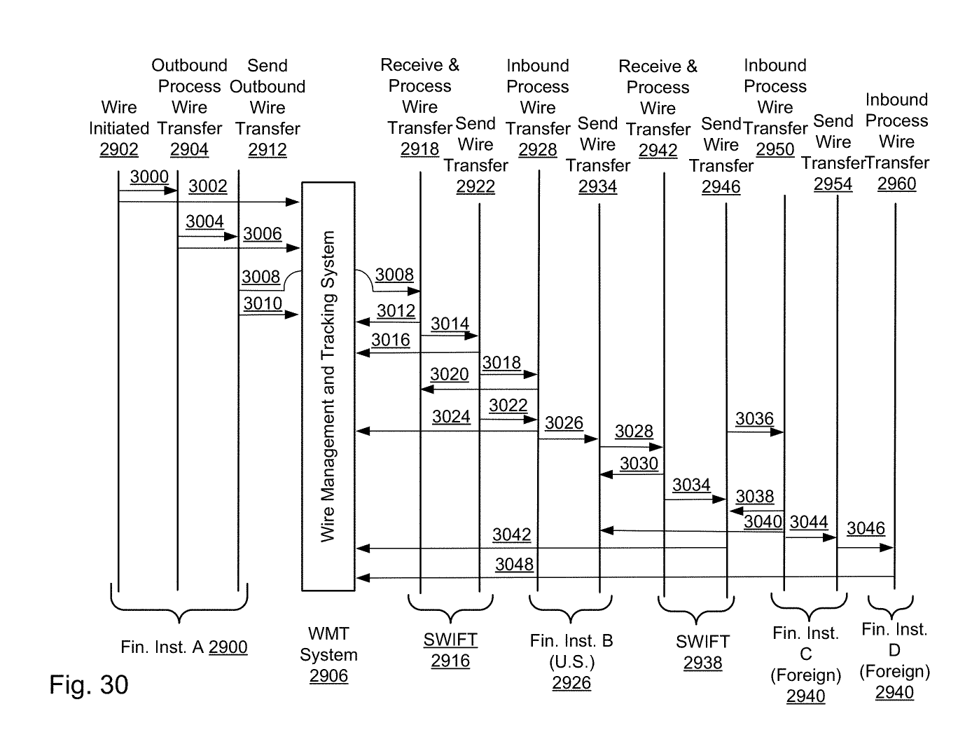

FIG. 30 is a signal path diagram that illustrates the message flow according to the wiring of funds illustrated in FIG. 27.

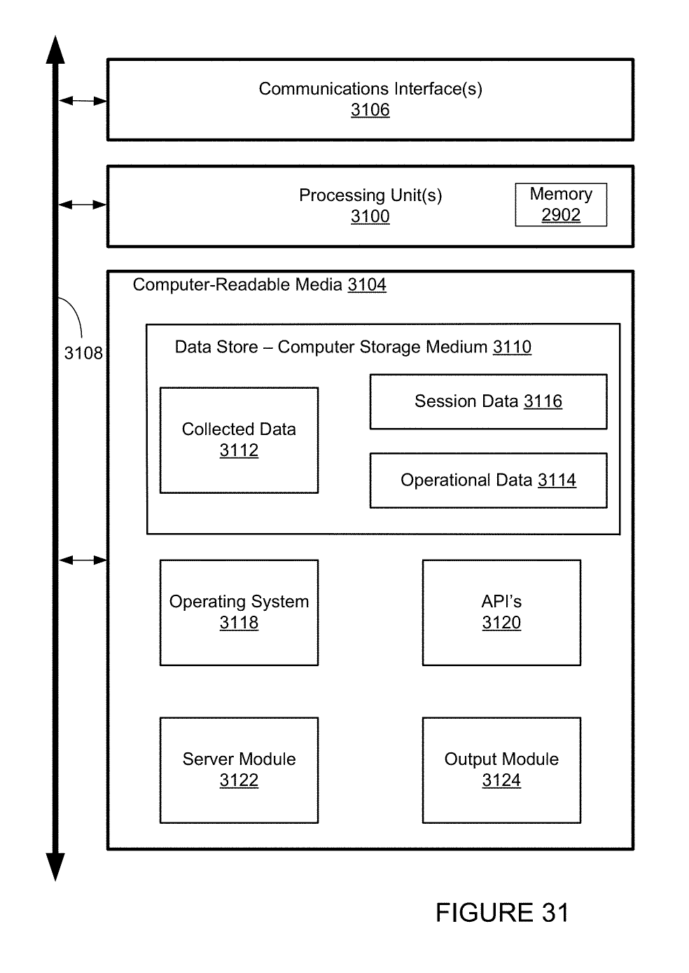

FIG. 31 is a block diagram illustrating an example of the hardware used in implementing the WMT system implemented in computer readable media such as software on computer hardware.

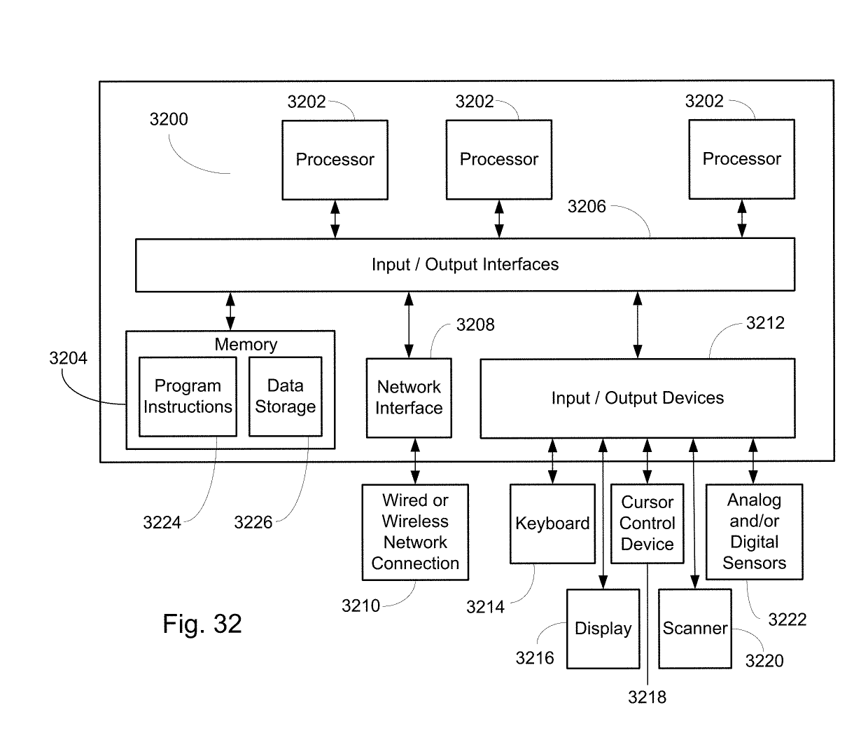

FIG. 32 is a block diagram illustrating the basic hardware configuration for implementing the WMT system.

### DETAILED DESCRIPTION

Overview.

A wire management and tracking system is provided for simplifying the creation and monitoring of the transfer of funds between financial institutions on behalf of their customers. An embodiment embeds a tracking number in the wire payment processing data at the time of initial preparation. The data is tracked at the locations of various financial institutions where the wire is sequentially processed via a payment processing system. Inserting a global tracking number into the payment data provides a number of tracking advantages to ensure the smooth flow of the funds along its flight path and their safe arrival at their intended destination.

Tracking wire payments has historically been limited to searches within one processing location (e.g., one financial institution) and it has not been linked between the financial institution's branch locations. Originating locations have been able to lookup processing destinations required to reach the final destination. Searching out the “in-flight” (in progress) wire payment is typically time intensive to perform and takes a coordinated effort between processing locations.

Wire payment origination is a manually intensive process that is prone to errors which lead to loss of payments, and delays in reaching their intended party due to rejections by processing location.

Structure of Wire Payment and Management System.

The WMT system is a global management and tracking system for wire transfer payments. There are five major processes involved, as well as a number of secondary operational processes. FIGS. 1 and 2 are high level block diagrams that illustrate the Wire Management and Tracking (“WMT”) system. FIG. 1 illustrates a high level block diagram of a wire transfer of funds where the party that initiates the funds transfer is the payor. FIG. 2 illustrates a high level block diagram where the payee initiates the wire transfer and the payor merely approves the wire transfer once the wire transfer request is received by the payor.

FIG. 1 is a block diagram illustrating an overview of the WMT system 300 (see FIG. 3) from the prospective of a sender (e.g., payor) wiring funds to a receiver (e.g., payee) and using a management and tracking system. The WMT system 300 may be designed so that some third party components and software may be used to add functionality to the WMT system 300. FIG. 1 illustrates a scenario when a payor 102 transfers funds to a payee 104. This is the traditional push system where a payor 102 owes a debt to a payee 104 or seeks to transfer funds to the payee's financial institution 108. In this scenario, the payor 102 completes a wire transfer request with a wire funds sender institution 106 such as a financial institution such as a bank, brokerage house, clearing house, credit union, etc. The payor 102 can initiate the transfer of funds by going in-person to the financial institution's offices or by accessing an online account with the financial institution where the account holding the funds to be transferred is located. The payor 102 input information about the wire funds receiver 108 and the payee's 104 account and contact information.

When the wire funds sender 106 transmits the funds, a series of messages 112 and acknowledgements 114 are exchanged between the wire funds sender 106 and the WMT system 110. Likewise when the funds are sent to the wire funds receiver 108 a series of messages 116 and acknowledgements 118 are exchanged between the wire funds receiver 108 and the WMT system 110.

FIG. 2 is a block diagram illustrating an overview of the WMT system 200 from the prospective of a receiver of funds who sends the sender a request to wire funds using the WMT system 200. This figure illustrates a scenario when a payee 202 sends a request to the payor 204 requesting the payor transfer and wire funds to a payee 202. This is best described as a pull system where a payee 202 send wire transfer information, including remittance information on a debt or financial obligation that is owed by the payor 204. The payor 204 can review the request and (1) approve a wire request sent by the payee 202; (2) deny the wire request sent by the payee 202; or (3) return a message to the payee 202 indicating that the payor 204 is sending an amount in excess of the request or an amount less than the request and why the payee's request is being modified.

In this pull scenario, the payee 202 completes a wire transfer request with its financial wire funds receiver institution 206 who requests the transfer of fund. The wire funds receiver 206 transmits at least one message 208 to the WMT system 210 and receives acknowledgements 212 from the WMT system 210 to the wire funds receiver institution 206. Once the request to transfer funds has arrived at the wire funds sender institution 206, the payor 204 can approve, deny or modify the transfer of funds and not have enter all the typical payment details of a request to send a wire that originates with the payor 204.

FIG. 3 is a block diagram illustrating the hardware and networking components of a non-specific funds transfer system using a management and tracking system. The WMT system 300 can electronically couple financial institution's wire payment processing systems 302 via a cloud network 304 or a dedicated secure connection (not shown) linking the WMT system 302 and the hardware 306 that supports the financial institution's wire payment processing system 302 together. The WMT System 300 can connect directly by a dedicated secure, physical connection 308 or indirectly via the Internet to the financial institution 304. The cloud network 304 may be secured interface connections via the Internet or encrypted data packets that are sent over an unsecure network. Dedicated networks could be employed using common architectures such as WAN, LAN, etc.

The financial institution wire payment processing system 302 facilitates customer interactions for creating wire transfer payments, viewing wire transfer payments, stopping wire transfer payments, and processes requests related to issues involving wire transfer payments. In addition, a WMT system 300 interfacing with the financial institution wire payment processing system 302 supports added functionality of allowing receivers of wire transfer payments to input data into the WMT system 300 which is then transferred to the financial institution wire payment processing system 302 and disclosed to the financial institution's customers. This wire transfer request payment information can include invoices and other information such that when it arrives at the sender's financial institution, the sender reviews the information and approves the wire transfer payment. In the alternative, the customer may approve part or none of the request for wire transfer payment. In these rejections or partial rejections of wire transfer processing, messages are returned to the intended receiver of the funds and approved or disapproved by the intended beneficiary of the wire transfer of funds.

The WMT system 300 can also connect directly with the financial institution's branch offices 308 as well as electronically couple with financial institution customer's mobile or fixed computer devices 310 via the cloud based network 304 and a secure web portal 312. Thus, a secure network connection can be established between the WMT system 300 and financial institution wire payment processing hardware systems 306 and/or the financial institution's customer access devices 310 via a secure web browser portal 312. The customer can then elect to wire funds via their own device 312 or they can go into the financial institution's branch offices 308 and access a wire payment terminal via a web browser portal 314.

Alternatively, a customer can process wire payment instructions or provide wire payment approvals directly by accessing a customer access in-house web portal 314 located at a branch office of the financial institution. In another embodiment, the customer can visit with a financial institution's representative and have the representative collect the wire payment transaction details or wire approval instruction and the representative can access the wire payment process via a secure web browser 316 or a dedicated network system that is used by the financial institution.

FIG. 4 is a block diagram illustrating the software components of a management and tracking system for wire payments with the implementation of at least one database and at least one software module. The software for the WMT system executes on a general purpose computer or server. The software comprises a primary code database 400 that is stored in the memory of the general purpose computer and is accessible by the microprocessor(s) that execute code as part of their functionality. The primary code database 400 is accessible by the tracking ID index 402 and the primary code index 404. The tracking ID index 402 comprises a list of wire payment transfer numbers used to track specific wire payments by the WMT system. The primary code index 404 comprises the primary code that is generated by the primary code index 404 and stored in the primary code database 400.

The software also comprises a transaction database 406 that is stored in the memory of the general purpose computer and is accessible by the microprocessor(s) that execute code as part of their functionality. The transaction database 406 is accessible by the wire payment tracking number module 408, the party code and express code number module 410 and the wire payment tracking processing module 412. The transaction database 406 comprises data regarding each wire transfer payment transaction that is occurring in the WMT system 300 with a tracking number as the primary key linked to other information such as the sender and the receiver information, e.g., sender/receiver customer and financial institution's name, and financial institution's customer account details, currency, amount, special instructions, remittance information, etc. A Wire Payment Tracking Number Module 408 can assign a unique tracking number in response to a wire payment tracking number request. A party code and express code number module 410 can assign the party code and/or express code and combines such code with receiver customer and the financial institution's details along with remittance information regarding the specific wire transfer.

The WMT system also has an accounting module 414 that can operate and interface with the primary code database 400 and the transaction database 406. The accounting module 414 can also operate and interface with the wire payment tracking number module 408, the party code and express code number module 410 and the wire payment tracking processing module 412. The accounting module 414 utilizes the transaction data related to wire transfer payments to determine fees and costs for using the WMT system that may be paid by the sending party, receiving party, the sending and/or receiving party's financial institutions or any combination of these parties or even a third party who is unrelated to the transaction or is not a part of the specific wire transfer.

Accounting Module 414 is also a centralized system that provides accounting functions for the WMT system 300. Some implementations could be coupled with a third party accounting system or a peer-to-peer accounting method. Furthermore, some implementations may not require an accounting module at all. An accounting of wire payments transactions could then be made on a periodic basis by having an accounting server check the local transaction databases of financial institution's wire payment processing module 302, or having such devices report their own records to such servers. This variation, therefore, uses a kind of electronic “meter checking” to monitor usage, processing, etc.

A wire payment analytics module 416 can operate and interface with all the WMT system components and provide analytics data regarding performance and efficiency, efficiency and trouble shoot problems and issues before they create slowdowns or stoppages in the wire transfer process. The analytics module 416 is used to analyze the records in the transaction database 406 for proactive and post-operation patterns that may positively or negatively affect wire transfer transaction costs or time. A variety of factors can influence the efficiency of the wire transfer process such as currency conversion, the number of intermediate financial institutions that process the transfer of funds, specific countries involved at the sending, receiving or intermediary points in funds transit, specific financial institutions, amount of the wire transfer, and layover time (e.g., the time the amount of money resides in the receiving account prior to subsequent transfers equaling the amount of the inbound funds). The module also calculates transaction performance statistics such as the time of processing for each location in the funds transfer process, volume of transfers, and percentage completion.

The WMT system provides solutions to problems associated with wire transfer payments, namely a real-time tracking of the wire transfer as it moves through various financial institutions. The WMT system allows all parties involved in the wire transfer of money (sender, receiver, sending institution, receiving institution, and transmitting institution (i.e. intermediary/corresponding institution)) to know accurately where the wire payment is currently being processed and where it has already been processed. The WMT system may use industry standard data from SWIFT to calculate the path (“flight paths”) for the wire transfer, to formulate a global tracking ID that ties the various institutions tracking information together, and to monitor the flow of the wire payment via the WMT system. The WMT system can operate as a cloud-based system or as a dedicated closed system that is proprietary to a financial institution's network.

The WMT is designed to simplify and expedite the creation of a wire transfer. One way the platform simplifies the process is by allowing the receiver of the wired funds to provide their information to the sender via codes generated by the WMT system prior to the sending of the wire in order to ensure that the wire's flight path is correct. Conversely, the sender of a wire transfer of funds can quickly set up a wire transfer using the same alphanumeric codes generated by the WMT system.

Wire payments are set up within the WMT system using a set of at least three codes: primary codes, party codes, and express codes. The primary code is an alphanumeric code that is generated using the customer ID of a sending or receiving financial institution. The WMT system, through integrating with a financial institutions internal system, can generate this code to identify an individual(s) associated within a financial institution, e.g., account holder(s). The party code contains the primary code plus an additional alphanumeric sequence that corresponds with the following data fields: name, address, phone, email, financial institution name, routing number and account number. The party code can be stored on the sending financial institution's wire recipients list for a specific consumer/business and can be reused to set up multiple wire payments. The express code contains the party code plus an additional alphanumeric sequence that corresponds to specific transaction details including some and all of the following: amount of funds being wired, the currency, remittance information, and specific contact details of the sender and receiver. Once the express code is used to initiate a wire payment, the WMT system creates a unique tracking ID that associates with the express code and is stored within the WMT system. The party code or express code provides account details that allow the sending financial institution to verify the information via the cloud-based API. In addition, either the party code or express code verification includes a secondary method to validate the sender's request via such mechanisms as PIN codes, biometric or any other secure methods, which may function as a “second key” validation method. A secure aspect of the party code and express code is that these two codes along with the primary code can be sent or provided to the sending party in an unsecure manner which is unlike current wire transfer system that require disclosure of the receiving party's account number which may then be associated with the receiving party and provide unscrupulous individuals starting information that can lead to the loss of funds via fraudulent means.

The use of codes such as an abstracted, arbitrary or random codes generated by the WMT system allows for securing sensitive customer data that may be transmitted in an unencrypted format between receivers and senders of wire payment transactions. In current wire systems, sensitive account information related to the receiver is often sent via email communications to the sender in order for the sender to gather the necessary information to send a wire and correctly route the wire through various intermediary parties. In such a scenario, the receiver's information is vulnerable to interception by unscrupulous individuals. With implementation of the WMT system, only the code generated by the WMT system is communicated to the sender for use when generating the wire payment which provides no useful information if intercepted by someone with fraud intentions.

Using either the party code or the express code, sending institutions can reduce the occurrence or even eliminate mistakes involving the transfer of wire fund payments to non-valid accounts at the receiver's financial institution since the codes are stored in the WMT system and validated by the receiving financial institution's database. The receiving financial institution can update the status of any party code or express code via the cloud-based API. The verification process, using second key security or other encrypted methodology, would provide financial institutions originating wire transfers plus any intermediary financial institutions the ability to verify the account information request and account holder information prior to initiating the wire payment to the intended account.

The generation of the party codes may be performed using the receiving or sending financial institution's portal and thus all the recipient routing information and account information will be accurate. Therefore, validation and/or updating may be automated, eliminating any manual data entry. Only the desired account can be selected from the financial institution's portal interface. The financial institution generated information reduces the verification process to simply verifying the name on the information provided by the WMT system when the financial institution's customers complete wire payment request forms.

The funds receiving party initiates the request for a wire transfer by accessing the WMT system. For example, the party requesting funds may provide remittance information, e.g., by uploading any necessary attachments for remittance, and/or by completing a WMT system template with any pertinent information for remittance. The system can then generate an express code containing the party code plus remittance information specific to the transaction), and transmit that code to the sender. The express code and any uploaded remittance information may be stored in the WMT system for association with the wire payment transaction by using the tracking ID.

The sender and/or receiver may attach remittance information, such as stored remittance information in the WMT system, related to the tracking ID. The remittance information sent can aid the sender's processing and reconciliation of wire transfer payments. If the receiver does not require remittance information, the receiver can provide the sender with a party code, but which does not contain any transaction specific information, but does include the name, account number, financial institution's information and routing number. The sender would then verify the receiver's information as the intended party for their transaction and then populates the receiver's financial institution information into the wire transfer template fields completing the wire transfer sending form with minimal review from the sending financial institution. For example, in an online wire system where a sender would access the WMT system via their financial institution's portal, the wire could be created with minimal review by the financial institution's wire operations staff. For larger institutions using a customized portal to access the WMT system supports the ability to send wires with minimal or no financial institution review once an initial training period for personnel is completed.

Once a wire payment has been initiated, the WMT system generates a unique tracking ID that is associated with the party code and/or express code. The tracking ID is then sent to the sender of the wire and the receiver of the wire by their respective financial institutions. The tracking ID can be used to track the location of the wire as it moves through the various financial institutions on its way to the receiver. Upon completion of the wire payment, the WMT system generates a “wire received receipt” which will be proof that the wire transaction was successfully completed. The wire received receipt is distributed to both the funds sender and funds receiver by the WMT system or their respective financial institutions.

For some types of financial institutions (e.g., escrow firms, brokerage houses, etc.), the WMT system can implement application specific features that may be hosted on the financial institutions customer's system so that the tracking IDs are inspected and then inserted into the customer's wire payment data prior to sending of the funds. A marker text could be inserted into the first several characters (e.g., WMTXX) of the Originator to Beneficiary Information (“OBI”) field of the wire transaction form, where the marker text may be automatically replaced with the tracking ID when it is assigned to the transaction by the WMT system. Another location in the wire transaction form and/or another type of marker and/or another number of characters may be used, as desired.

In another embodiment, wires of funds may be created in a sending financial institution and may be required to have the marker text as the first four characters of the OBI field. The payment data for such wires would then be passed to the WMT system to put the tracking IDs into such wires. The sender's, receiver's, and transmitting institution's information are or may be stored in the WMT system in relation to the tracking ID. The intention for this variation is to put the immediate benefit of tracking into place with the least impact to financial institution's existing wire intake process, since the OBI is an existing field that is optional for current wire senders. The tracking ID essentially serves as a marker or beacon for tracking the wire, by each institution that receives the wire storing the tracking ID and/or sending it to the WMT system. The tracking ID is transmitted by the financial institution along the flight path (e.g., the path that the wire travels from start to finish) by scanning the wire payment data for the tracking IDs. These IDs along with a day/time stamp are transmitted to the WMT system via the WMT system's API and update the tracking ID processing history with location information for the wire.

For financial institution that want all wires to be tracked by the WMT system, the WMT system may process specified wire payment data and append in the OBI field the tracking ID and then update the wire payment data to be processed by the financial institution.

FIG. 5 is a table illustrating the primary code, party code, express code used in a wire management and tracking system. The primary code is an alphanumeric code that is generated using the customer ID of a sending or receiving financial institution. The WMT system can communicate with financial institutions internal computer systems in order to generate the primary code that identifies customer(s) who have accounts at particular financial institutions. For example, the WMT system can connect to a financial institution such as Bank of America and create a customer ID associated with John Doe and assign Mr. Doe the Customer ID of jsmith2000.

The party code contains the primary code plus an additional alphanumeric sequence that represents a customer's account number, a financial institution's account routing number, contact information of the customer (name, address, email, fax, etc.). By entering a party code through a sending or receiving financial institution, a sender or receiver can pre-populate the necessary data fields that initiate a wire transfer except for the amount of funds to wire. The sender or receiver will still need to enter the amount of funds to wire through the associated financial institution.

The express code is an additional alphanumeric sequence containing the payee information plus information regarding the specific wire transfer transactional information. This information can include amount of funds to be wired, the currency of the wire and remittance information specific to the wire (e.g., invoice, diagrams, purchase orders, etc.). By inputting the express code at the sending or receiving financial institution, the sender or receiver of funds can pre-populate all of the necessary fields to initiate a wire transfer as well as attach any associated remittance information. Once a wire is initiated, the WMT system creates a tracking number that associates with the aggregate alphanumeric sequence that includes the primary code, the party code plus express code. This tracking number is stored in the primary code database.

The table presented in FIG. 5 illustrates the code description in the top row with example codes listed on the second row and a description of the information represented in each code listed. For example, the primary code, party code and express code can have alphanumeric and special characters and their size can be of fixed or variable length. If variable length character fields are selected, check sums and other controls can be implemented so that the WMT system knows the size of the data field for the code.

Operation of the WMT System.

FIG. 6 is a flow chart illustrating the process for generating the WMT system tracking numbers and calculating compensations from the flight paths with the WMT system. The WMT system reviews and analyzes flight path data and the typical transaction time from wire initiation to wire receipt. This data is used to provide an estimated time of arrival for each wire and will be attached to the tracking ID. Additionally, the WMT system provides the ability to stop a wire payment that is in-flight by signaling the various beacons along the wire's flight path.

A wire tracking number is generated to globally link the wire payment between the payor and the payee. When a wire payment is initiated 600, the wire payment content 602 is entered into the WMT system. A file is created and stored in a memory location having a file format that can be structured to meet the format requirements of the Federal Reserve Wire Network (“Fedwire”) such as the Fedwire Funds Service or SWIFT protocols. A number of well-known file types for electronic sending of payments can be put into a suitable form for tracking and management in the WMT system. The WMT system then creates a wire tracking number 604.

The tracking number 604 is generated by the wire tracking number module 408 and stored 606 in the transaction database 406. The tracking number contains of an alphanumeric sequence which may be created by combining the primary code with the party code and the express code along with a day and time stamp (e.g., Tracking Number=primary code+party code+express code+day timestamp). The flight path 608 is pulled from Fedwire, SWIFT or another institution's database of flight paths. From receipt of the flight path 608 of the wire transfer funds, compensations 610 can be calculated in order to insure that the various institutions along the flight path are compensated for their services and stored in the transaction database 406. The compensations 610 may be used as settlement for enabling the WMT system 300 to gather wire payment information processed at an institution's various locations.

FIG. 7 is a flow chart illustrating an alternative embodiment process for generating the WMT system tracking numbers and calculating compensations from the flight paths with the wire management and tracking system. FIG. 7 tracks FIG. 6 and includes additional optional steps. The originating location runs a copy of the wire payments processing module 302 on financial institution's wire payment processing module 302 to read the wire payment details in the wire payment data. Typically, the wire payment data would include all the information that might be useful for tracking within the primary code database 400 and the transaction database 406. For example, the following information can be collected and used:

Sender name

Sender address

Sender email address

Sender phone number

Sender's financial institution name

Sender financial institution's address

Sender financial institution routing number

Sender customer financial institution account number

Receiver name

Receiver address

Receiver email address

Receiver phone number

Receiver financial institution's name

Receiver financial institution's address

Receiver financial institution's routing number

Receiver customer financial institution's account number

Special instructions

Wire tracking system codes (primary codes)

Processing location ID

Day and timestamp

In an alternative embodiment, additional functionality can be added to the process illustrated in FIG. 6 by having the WMT system place 702 the wire payment file into a secure intermediary file system folder on the financial institution's wire payment processing network 302 indicating that the file has been processed by the WMT system 300 and is now ready to be moved into the location the financial institution uses to process inbound and outbound wire payments to their backend operation systems. If any errors occur during the process of generating wire payment tracking numbers or updating the wire payment file, the file may be placed in alternative locations accessible by the financial institution's wire payment processing module 302 to indicate when intervention is required.

In another alternative embodiment, another option may include setting the wire payment location by the wire payment tracking module 302. The wire payment location is set to the current processing location ID for each transaction in the transaction database 406 with respect to each of the wire tracking numbers generated during the file processing. Most commonly, the information transmitted from the processing institution to update the tracking number is: location ID, tracking number, and day and timestamp.

FIG. 8 is a flow chart illustrating the creation of party codes by the WMT system. In a centralized system, WMT system 300 can performs this function, while in a decentralized or distributed system the financial institution 302 can perform this function. The wire transfer process involves the creation of the party code that is used to minimize and/or eliminate errors in data entry of the relevant information associated with the receiver and the receiver's financial institution. The transmission of payee information is done is a secure fashion and none of the information is open to compromise as transmission is done via a secure financial institution's interface.

Party Code and Express Code Generation.

As part of the wire payment creation processes, a party code and/or express code can be created. The express code alphanumeric sequence is similar to that of the party code with additional digits to represent the transaction (e.g., express code=party code+additional characters). The first step is for the financial institution's wire payment processing module 302 to gather relevant information, e.g., relating to the following:
receiver name
account details (account address, email associated with the account, user ID, phone number)
financial institution's name
financial institution's address
financial institution's phone number
routing information
   The receiver information is used for communication with the party code and express code number module 410 of the WMT system 300.

The process starts 800 when the WMT system 300 prepares the financial institution information 802 for the wire transfer. The wire information gathered and transmitted to the party code and personal identification number (“PIN”) can be created from the party code and express code number module 410 for use by the sender at the time of a wire payment creation. The sender of the funds or the receiver of the funds could create the PIN at the time the account is created or just for a specific wire transaction. Thus, it is conceivable that an account could have a PIN for conducting wire transactions and a separate, more secure PIN for accessing the account's debit card attached to the account. The party code and PIN are stored in the transaction database 406 along with the previous information gathered 802.

The party code may be linked to future wire payment transactions and updated via the receiving financial institutions' customer portal. This allows the receiver to update their financial institution's account number, address, etc. for a specific party code, since the party code is intended to be reusable, and when a financial institution's customer is removed from the account the financial institution and/or customer must subsequently inform the WMT system 300 so that the code is invalidated to eliminate any future wire payments to the account.

FIG. 9 is a flow chart illustrating the creation of express codes by the WMT system. This process involves the generation of the express code that comprises the party code plus specific transaction related information and is used by the sending party. This process is outlined in FIG. 9 and alternative options are outlined in FIG. 10.

Instead of party code generation and a specific transaction code, the express code incorporates both the party code and the specific transaction code. The process of generating the express code starts 900 with the preparation of the financial institution's wire payment processing module 302 which gathers the relevant information 902 for the wire transfer. This information can include:
receiver name
account details (account address, email associated with the account, user ID, phone number)
financial institution's name
financial institution's address
financial institution's phone number
financial institution routing information
   The receiver financial institution information 902 may be used to create the party code and express codes by the party code and express code number module 410 of the WMT system 300.

The specific transaction details such as currency, amount of funds requested, special instructions, attached remittance information (e.g., invoices) are populated 904. The transaction specific information is gathered via the customer network device 310 for transmission to the financial institution's wire payment processing module 302 and transmitted to the WMT system 300 for use by the party code and express code number module 410.

The information gathered 902 and 904 are transmitted from the financial institution's wire payment processing module to the WMT system 300 for use by the party code and express code number module 410. The party code and express code number module 410 generates the express code and PIN 906 for use by the sender during the wire transfer process.

The express code and all associated information gathered 902, 904 and 906 are stored in the transaction database 406. The information is linked to a specific wire payment transaction that is to be generated in the future by the sender. The information could also be linked at the time of the wire payment tracking number generation.

Creation of Party Codes and Express Codes.

FIG. 10 is a flow chart illustrating the process for creating party codes and express codes by the WMT system. This process involves the creation of wire payments using either a party code or express code. The wire payment initiation processing is typically a substantially manual process for the sender. By using a process in accordance with an embodiment or embodiments of the invention providing an online approach which uses selected account information from the sender and the party code or express code for the receiver, the process is significantly simpler for the sender. This process is outlined in FIG. 10 and alternative options are outlined in FIG. 11.

Information is retrieved related to the receiver of the wire payment as provided by the receiver's institution. In a centralized system, WMT system 300 can performs this step, while in a decentralized or distributed system, the financial institution 302 can perform this step.

The receiver information is linked to the wire payment in the transaction database 406 using the sender's unique primary code generated from the primary code index 404 and stored in the primary code database 400 when the sender requests making a wire transfer of funds. The primary code database 400 can be queried by the WMT system 300 for the financial institution's information (e.g., location ID, account number, customer ID) in order to determine the primary code that to link the outgoing wire transfer recipient's primary code once the recipient's code is provided by the party code or express code.

The sender populates 1004 the receiver information using the primary code (e.g., party code and/or express code) provided by the receiver along with an authorization PIN that is used by the party code and express code number module to validate and retrieve wire payment transaction data stored in the transaction database 406. The PIN can be created by the receiver at the time of creation on the financial institution's interface. The PIN may be permanent in the case of party code, but changeable if necessary, or individual transaction specific as in the case of the express code.

In an alternative embodiment shown in FIG. 11, additional functionality can be added to the process illustrated in FIG. 10. The sender verifies the information 1100 in the wire transfer form and acknowledges the validity of the transaction as a final step prior to submission by the sender's institution.

The sender may input currency, amount, and special instructions 1100 that are stored in the transaction database 406. This step is optional such as when the receiver did not create transaction specific data in the form of an express code.

The institution may review and approve wire payments prior to sending 1102. This step is typically performed in the initial stages of onboarding new clients and may be excluded upon an established level of confidence with the new client. This step is similar to when a sender fills out an institution's wire request form using the institution's existing wire software/system, such as Treasury Net available through City National Bank, Los Angeles, Calif. In that system, the sender fills in all the wire information and then the financial institution's wire department reviews the wire and sends it out.

The sender may optionally attach additional remittance information 1102 desired by the sender and receiver to reconcile the transaction. The remittance information will be stored in the transaction database 406 in an encrypted format pursuant to privacy protection standards.

FIG. 12 is a flow chart illustrating the process for extracting wire fund payments by the WMT system. This primary process involves the tracking of a wire payment from its initial creation, along its path, and upon final delivery to the end destination. This process is outlined in FIG. 12 and alternative options are outlined in FIG. 13.

Wire Payment Tracking Processing.

FIG. 13 is a flow chart illustrating an alternative embodiment of the process for extracting wire fund payments by the WMT system. As illustrated, the first step is preparing the wire payment content 1202 representing the movement of the wire payment data for processing by the wire payment processing module 302 at the wire transfer sending institution.

The wire payment processing module 302 can extract the wire tracking numbers from the payment data 1202 and communicates 1204 with the wire payment tracking module 302 providing the wire tracking number, the processing institution's location ID, along with the day and timestamp and any local transaction ID for the payment at the financial institution's wire payment processing module 302.

The wire payment processing module 302 updates 1206 the transaction database 406 with the information related to where the payment is being processed. Most commonly, the information transmitted from the processing institution to update the tracking number is: location ID, tracking number, and day and timestamp.

The wire payment processing module 302 moves the wire payment computer file on the financial institution's wire payment processing module 302 to a staging location that indicates it is completed with processing 1208 and is ready to continue with the financial institution wire transfer payment processing.

A variation of the wire payment data can be passed via SWIFT API messages. The financial institution's wire payment processing module 302 returns the updated wire payment data for continued processing by the financial institution. The accounting module 414 calculates compensation 1210 for the processing institutions based upon updates communicated via the wire payment processing module 302.

In addition, the financial institution may utilize blockchain ledgers to settle the wire payment transactions. In this scenario, the tracking ID is inserted into the ledger for correlation if the need arises during settlement as specified in FIG. 16.

FIG. 13 is a flow chart illustrating an alternative embodiment of the process for tracking wire fund payments by the WMT system. This process calculates the flight plan for a wire payment. In this alternative embodiment, additional functionality can be added to the process illustrated in FIG. 12. The wire payment processing module 302 may update 1300 the wire payment data as well as updates local log file. In the case of updating the wire payment data (e.g., the amount identified for stopped payment requests is set to zero), the wire payment processing module 302 alerts wire room personnel of any potential issues (e.g., stop payment activity).

Wire Tracking Flight Plan Calculations.

As illustrated in FIG. 14, the process starts 1400 by retrieving the sender's and receiver's financial institution information for use in flight plan lookup. Flight path information is gathered 1402 from SWIFT's list of financial institutions and their respective intermediary parties. The flight plan information is fed to a third party service provider which provides intermediary and corresponding financial institution's routing information necessary to wire payments between sending and receiving institutions.

A third party service may be utilized 1404 to populate the wire payment form and/or for wire payment location research, as possible. For example, a SWIFT service may be used to provide a SWIFT code and/or a SWIFT lookup of the intended path and compare such path to the locations obtained by the system during the wire payment processing at the various institutions.

The wire payments analytics module 414 may periodically review the transaction database 406 to calculate transit times 1406 between institutions, number of transfers to/from institutions, daily total amount of transfers to/from institutions, etc. The transaction database 406 may be updated with flight plan and metric data calculated. The transaction database 406 may be queried to generate reports for usage and other key metrics 1408, and then this process ends 1410.

Wire Transfer Velocity Monitoring.

FIG. 15 is a flow chart illustrating the process for performing wire payment analytics by the WMT system 300. The WMT system 300 has the capability to monitor the wire transfer process collecting various data during the wire transfer process for processing by analytics software. The WMT system starts 1500 by collecting pre-selected data such as the timing of various messages sent or received during the wire transfer process. This information is gathered and stored in the WMT system 1502. The WMT system's analytics module 416 manages the collection of message flow data and performs the diagnostic analysis on the collected data. Flight paths 1504 can be requested from various third party sources 1504 and the WMT system can calculate 1506 the flight metrics to ensure efficiency in the wire transfer process. The transaction database can then be updated with the flight plan and other data to ensure fast and efficient delivery of the wired funds as a transaction ends.

The WMT system's analytics module 416 can use timing, wire transfer amounts, destination and source country information to identify high-velocity transfers that are routine and successive. One of the intended goals of the analytics software is to identify patterns of wire transfers. Thus, the data analytics can indicate whether the wired funds were merely passed through from one financial institution to another or whether the wired funds reached their true intended final destination.

As more transactions move through the WMT system, the WMT system can implement a set of analytic software that receives data input from wire transfer transactions moving through the WMT systems and can inform the sender, receiver, and their respective financial institutions estimated processing times for future or existing wire transfer transactions and also identify and communicate to the financial institutions any inefficiencies discovered in the wire transfer process. Through the collection of historical flight paths, the WMT system, can determine the average processing time for a wire transfer along a particular flight paths, identify where inefficiencies along the flight path exist, and provide recommendations to the financial institutions and/or specific networks such as Fedwire and SWIFT what alternative flight paths exist so that future wire transfers can use historical data collected by the WMT system to improve the efficiency of the wire transfer process.

Using the above analytics created by the WMT system, financial institutions could offer more transparency to their customers and perhaps provide tiered pricing to the sender or receiver based on estimated delivery times and their associated flight path. Moreover, all financial institutions across the wire payment flight path would have visibility into the performance of their back office processing of wire payments in comparison to industry standards and have visibility into what intermediary financial institutions are slowing down the processing customers' of wire transfers.

Generating a Wire Payment Transaction Using Blockchain.

FIG. 16 is a flow chart illustrating the process for using a blockchain ledger to record a transaction performing wire payment analytics by the WMT system. In FIG. 16, wire transfers may be settled using blockchain technology. In this scenario, the intermediary financial institutions may be eliminated as a means of settlement of fund transfers as the blockchain contains information necessary to document wire transfer transactions. The process of sending a wire transfer would start 1600 with the creation of the wire transfer payment data 1602. The WMT system would generate the tracking ID 1604 and associate the tracking ID with the primary code, party code and express code data. The wire transfer transaction would then be recorded in the blockchain ledger 1606 which would be updated with the wire payment transaction data along with the tracking ID. The financial institution would then process the wire transfer payment 1608. The blockchain ledger is synchronized with the financial institutions who participate in using the blockchain service and the participating financial institutions would synchronize their records after a predetermined time has elapsed 1610 (e.g., every five (5) or ten (10) minutes), thus summarizing all the transactions that have occurred since the last synchronization of transactions. The wires transferred during the predetermined time would show up as incoming wire transfers and the process would end 1612.

Wire Payment Tracking Variations.

As highlighted in FIGS. 17-28, wire payments have a variety of mechanism of transfer with one or often multiple processing points along the path to the final recipient. A fully constructed flight path of the actual path and wire payment tracking could be assembled from the transaction database 408. The linking of the tracking ID's could be constructed during the synchronization of localized IDs generated along the path as a variation to the centralized model based upon the origination point.

Stopping in Progress Wire Payments.

Wire payment “velocity” information which forms part of the analytics and diagnostic system of the WMT system can enable determination of approximate wire transit time from initiation of the wire by the sending financial institution a receipt of the wire by the receiving financial institution. This velocity information may vary from country to country, and possibly from financial institution to financial institution, and depending upon whether intermediary financial institution s are used, and possibly other factors. In any event, with the knowledge of approximate wire transit time, the sending financial institution will know it has a specific time frame in which to stop a wire. Stopping a wire payment would be initiated by the sending financial institution holding the funds at a particular moment in the process a stop wire process message.

Therefore, a short time limit on stopping a wire is in the interest of maintain the integrity of the system. Once the wired funds reach its intended destination (e.g., the payee's account), stopping a wire payment could still be possible in order to maintain the integrity of the wire system and unwind financial transactions involving fraud.

The WMT system 300 allows the ability of parties to stop wire transfers if initiated by authorized representatives at the sending institution via the wire payment processing module 302. This can be accomplished by flagging the wire transfer tracking number as invalid. When other institutions processing the wire transfer (e.g., intermediary financial institutions, corresponding financial institutions, etc.) wire payment processing module 302 communicating with the WMT system 300, an invalid message relating to the wire payment tracking number. At that time, the financial institution holding the funds places a freeze on the funds until proper ownership of the funds can be established.

The wire transfer processing module 302 operated by the financial institution in response to the negative or invalid response updates with the WMT system 300 the wire tracking number can be logged as problematic and flagged for additional review by the various financial institutions in the funds flight path.

Generating Messages During Wire Transfer Process.

When wire transfers are initiated by a sender, the process of initiating, processing, and transmission of wire transfer process creates several scenarios for the process flow of the transfer from the sender of funds to the receiver of the funds. At any stage of the process, the WMT system can provide updates to the fund's sender, sending financial institution, and/or any intermediary financial institution that wishes to track the wire through its flight path and receive progress reports on the fund's location and whether the funds have arrived in the payee's account. Such messaging can be accomplished via email, text, and/or available in a log on the WMT system server by an authorized party. Therefore, the sender of the wire can receive a receipt or confirmation of payment to the payee, which could operate as a receipt proving arrival of the funds at the desired destination.

FIGS. 17-30 illustrate the steps and message signal paths of messaging between the WMT system and the financial institutions along the flight paths of various examples of wire transfers. FIG. 17 is a block diagram illustrating a wire of funds in the United Stated using Fedwire and interactions with the wire management and tracking system. FIG. 17 represents an example of message flow of the transmission of Unites States domestic wires utilizing the Fedwire settlement and transmission services with status updates. Financial institution A 1700 initiates a wire transfer 1702 of funds and starts the outbound wire transfer process 1704. The financial institution's wire transfer processing module 302 processes the wire transfer data with the primary code and communicates with the WMT system 1706 to register the primary code status update “Initiated” 1708. The outbound wire status is updated to “Received” 1710 prior to sending to the financial institution's backend systems for processing 1712. The outbound wire status is updated to “Sent” 1714 after sending the wire transfer to the Fedwire system via a payment or transfer order.

The wire transfer is registered once it arrives in the Fedwire system 1716 and credit/debits are applied in the Fedwire settlement system 1718. Acknowledgement of financial institution A's transfer of funds to financial institution B is confirmed 1720 and the wire payment status is updated to “Received” 1718 by the Fedwire system via an API call to the WMT system 1706. The sending of a funds transfer order 1722 and related advice of the wire payment to financial institution B 1726 is accomplished by Fedwire while communicating with WMT system 1706 to update to the wire payment status to “Sent” 1724. Financial institution B 1726 uses financial institution's wire transfer processing module 302 to update the inbound status 1728 of the wire transfer in WMT system 1706 to “Received” 1730.

FIG. 18 is a signal path diagram that illustrates the message flow according to the wiring of funds illustrated in FIG. 17. When a wire of funds is initiated 1800 at a first financial institution A 1700, the wire transfer instructions are passed 1800 within financial institution A 1700 from the wire initiated stage 1702 to the outbound wire transfer stage 1704. At approximately the same time, a message 1802 is sent from the financial institution A 1700 to the WMT system 1706. When the outbound process wire transfer 1704 passes 1804 the wire transfer to the send out bound wire transfer stage 1712, another message 1806 is sent to the WMT system 1706.

At this point, financial institution A 1700 sends 1808 the wired funds to Fedwire 1716, a message 1810 is sent by financial institution A 1700 to the WMT system 1706. Upon receipt of the wired funds at Fedwire 1716, a message 1812 is sent by Fedwire 1716 to the WMT system 1706 indicating that the wired funds 1808 have arrived 1718 at Fedwire 1716. Once Fedwire receives and processes the wire transfer 1718 the funds are internally prepared to be sent to the next financial institution. When the funds are ready to be sent 1814, Fedwire 1716 sends a message 1816 to the WMT system 1706. The funds are then transferred 1818 from Fedwire 1716 to financial institution B 1726. When the funds arrive at financial institution B 1726, a message 1820 is sent to the WMT system 1706 thus completing the wire transfer messaging. Throughout the wire transfer process, the sender of the funds, the sender's financial institution 1702, the recipient, the recipient's financial institution B 1726 and any intermediary parties can log into the WMT system 1706 and review the funds progress. The SMT system 2906 is capable of operating independently of other third party messaging services so that the third party messaging service can continue to operate if desired by a financial institution.

FIG. 19 is a block diagram that illustrates the messages sent using the WMT system for the transmission of a U.S. originating international wire transfer of funds to another country's financial institution using Fedwire and a U.S. beneficiary financial institution prior to sending the funds to a foreign country's financial institution. Financial institution A 1900 initiates a wire transfer 1902 of funds and starts the outbound wire transfer process 1904. The financial institution's wire transfer processing module 302 processes the wire transfer data with the primary code and communicates with the WMT system 1906 to register the primary code status update “Initiated” 1908. The outbound wire status is updated to “Received” 1910 prior to sending to the financial institution's backend systems for processing 1912. The outbound wire status is updated to “Sent” 1914 after sending the wire transfer to the Fedwire system via a payment or transfer order.

The wire transfer is registered once it arrives in the Fedwire system 1916 and credit/debits are applied in the Fedwire settlement system 1918. Acknowledgement of financial institution A's transfer of funds to financial institution B is confirmed 1920 and the wire payment status is updated to “Received” 1918 by the Fedwire system via an API call to the WMT system 1906. The sending of a funds transfer order 1922 and related advice of the wire payment to financial institution B 1926 is accomplished by Fedwire 1908 while communicating with WMT system 1906 to update to the wire payment status to “Sent” 1924. Financial institution B 1926 uses financial institution's wire transfer processing module 302 to update the inbound status 1928 of the wire transfer in WMT system 1906 to “Received” 1930. Financial institution B's foreign location 1932 (e.g., beneficiary financial institution foreign location) receives an internal massage as an internal financial institution transfer 1934 for benefit of the receiver of the wired funds. Once the wired funds arrive at the financial institution foreign beneficiary institution 1932 message 1936 is sent to the WMT system 1906 confirming delivery of the wire funds.

FIG. 20 is a signal path diagram that illustrates the message flow according to the wiring of funds illustrated in FIG. 19. When a wire of funds is initiated 2000 at a first financial institution A 1900, the wire transfer instructions are passed 2000 within financial institution A 1900 from the wire initiated stage 1902 to the outbound wire transfer stage 1904. At approximately the same time, a message 2002 is sent from the financial institution A 1900 to the WMT system 1906. When the outbound process wire transfer 1904 passes 2004 the wire transfer to the send out bound wire transfer stage 1912, another message 2006 is sent to the WMT system 1906.

At this point, financial institution A 1900 sends 2008 the wired funds to Fedwire 1916, a message 2010 is sent by financial institution A 1900 to the WMT system 1906. Upon receipt of the wired funds at Fedwire 1916, a message 2012 is sent by Fedwire 1916 to the WMT system 1906 indicating that the wired funds 2008 have arrived 1918 at Fedwire 1916. Once Fedwire receives and processes the wire transfer 1918 the funds are internally prepared to be sent to the next financial institution. When the funds are ready to be sent 2014, Fedwire 1916 sends a message 2016 to the WMT system 1906.

The funds are then transferred 2018 from Fedwire 1916 to financial institution B 1926 located in the United States. When the funds arrive at financial institution B 1926, a message 2020 is sent to the WMT system 1906. The financial institution B 1926 then sends 2022 the wired funds to its foreign location 1932 and a message 2024 is sent to the WMT system 1906 indicating that the wire transfer is complete and the funds have arrived at their desired destination. Throughout the wire transfer process, the sender of the funds, the sender's financial institution 1902, the recipient, the recipient's financial institution B 1926 and any intermediary parties can log into the WMT system 1906 and review the funds progress. The SMT system 2906 is capable of operating independently of other third party messaging services so that the third party messaging service can continue to operate if desired by a financial institution.

FIG. 21 is a block diagram that illustrates the messages sent using the WMT system for the transmission of a U.S. originating international wire transfer of funds to another country's financial institution using Fedwire and a U.S. beneficiary financial institution prior to sending the funds to a foreign country's financial institution. Financial institution A 2100 initiates a wire transfer 2102 of funds and starts the outbound wire transfer process 2104. The financial institution's wire transfer processing module 302 processes the wire transfer data with the primary code and communicates with the WMT system 2106 to register the primary code status update “Initiated” 2108. The outbound wire status is updated to “Received” 2110 prior to sending to the financial institution's backend systems for processing 2112. The outbound wire status is updated to “Sent” 2114 after sending the wire transfer to the Fedwire system via a payment or transfer order.

The wire transfer is registered once it arrives in the Fedwire system 2116 and credit/debits are applied in the Fedwire settlement system 2118. Acknowledgement of financial institution A's transfer of funds to financial institution B is confirmed and the wire payment status is updated to “Received” 2120 by the Fedwire system via an API call to the WMT system 2106. The sending of a funds transfer order 2122 and related advice of the wire payment to financial institution B 2126 is accomplished by Fedwire 2108 while communicating with WMT system 2106 to update to the wire payment status to “Sent” 2124. Financial institution B 2126 uses financial institution's wire transfer processing module 302 to update the inbound status 2128 of the wire transfer in WMT system 2106 to “Received” 2130. Financial institution B's 2126 (e.g., beneficiary financial institution) receives an internal massage as an internal financial institution transfer 2134 for benefit of the receiver of the wired funds. Once the wired funds are sent out from financial institution B 2126, a message 2136 is sent to the WMT system 2106 confirming transmission of the wired funds.

Financial institution B 2126 transmits the wire payment 2134 via SWIFT 2138 to financial institution C 2140 (e.g., beneficiary financial institution foreign location). Financial institution B 2126 communicates a “push” message to SWIFT 2138 and receives an “acknowledgement” from SWIFT 2138 of the wire transfer. Financial institution B 2126 uses its financial institution wire payment processing module 302 to update the status of the wire payment in the WMT system 2106 to “Sent” 2136.

SWIFT sends an acknowledgement to financial institution B providing feedback that the transfer to financial institution C 2140 is confirmed, and the wire payment status is updated to “Received” 2144 by the SWIFT system 2138 via an API call to the WMT system 2106. SWIFT 2138 signals via its send wire transfer 2146 to financial institution C 2140 that it is facilitating a wire transfer payment and the wire payment status is updated to “Sent” 2148 via an API call to the WMT system 2106. Financial institution C 2140 (e.g., beneficiary financial institution foreign location) receives the wire payment transfer from SWIFT 2138 and processes the transaction. Financial institution C 2140 uses its financial institution wire payment processing module 302 to update the inbound process wire transfer 2150 status of the wire payment in a status message in the WMT system 2106 to “Received” 2152.

FIG. 22 is a signal path diagram that illustrates the message flow according to the wiring of funds illustrated in FIG. 21. When a wire of funds is initiated 2200 at a first financial institution A 2100, the wire transfer instructions are passed 2200 within financial institution A 2100 from the wire initiated stage 2102 to the outbound wire transfer stage 2104. At approximately the same time, a message 2202 is sent from the financial institution A 2100 to the WMT system 2106. When the outbound process wire transfer 2104 passes 2204 the wire transfer to the send out bound wire transfer stage 2112, another message 2206 is sent to the WMT system 2106.

At this point, financial institution A 2100 sends 2208 the wired funds to Fedwire 2116, a message 2210 is sent by financial institution A 2200 to the WMT system 2106. Upon receipt of the wired funds at Fedwire 2116, a message 2212 is sent by Fedwire 2116 to the WMT system 2106 indicating that the wired funds 2208 have arrived 2118 at Fedwire 2116. Once Fedwire receives and processes the wire transfer 2118 the funds are internally prepared to be sent to the next financial institution. When the funds are ready to be sent 2214, Fedwire 2116 sends a message 2216 to the WMT system 2106.

The funds are then transferred 2218 from Fedwire 2116 to financial institution B 2126 located in the United States. When the funds arrive at financial institution B 2126, a message 2220 is sent to the WMT system 2106. The financial institution B 2126 then passes 2226 the wired funds to the send wire transfer position 2134 within financial institution B in the United States 2126.

Financial institution B 2126 then sends the wired funds 2228 to SWIFT 2138 where an acknowledgement 2230 is sent by SWIFT 2138 to financial institution B 2126 and a message 2232 is sent to the WMT system 2106. SWIFT 2138 then passes 2234 the wired funds from the received and process wire transfer 2142 to the send wire transfer 2146. The wired funds are then sent 2236 by SWIFT 2138 to financial institution C 2140. A SWIFT acknowledgement 2238 can be sent by financial institution C 2140 to SWIFT 2138. The recipient financial institution C 2140 may also be requested to send an acknowledgement represented by a “Long ACK” 2140 to financial institution B 2126.

This SWIFT message 2242 from financial institution C (foreign) 2140 to WMT system 2106 indicating that the wired funds have arrived would be viewable and accessible to financial institution B 2126. Message 2242 and SWIFT messages 2238 and 2240 alert WMT system 2106 and various intermediary parties that the funds have arrived at their destination. Throughout the wire transfer process, the sender of the funds, the sender's financial institution 2102, the recipient, the recipient's financial institution C 2140 and any intermediary parties can log into the WMT system 2106 and review the wired funds progress. The SMT system 2906 is capable of operating independently of other third party messaging services so that the third party messaging service can continue to operate if desired by a financial institution.

FIG. 23 is a block diagram that illustrates the messages sent using a wire management and tracking system during the transmission of a wire payment to another country's financial institution using Fedwire to route the funds to a United States beneficiary financial institution and SWIFT to route the funds to a first foreign country's financial institution and then to a second financial institution in that foreign country. Financial institution A 2300 initiates a wire transfer 2302 of funds and starts the outbound wire transfer process 2304. The financial institution's wire transfer processing module 302 processes the wire transfer data with the primary code and communicates with the WMT system 2306 to register the primary code status update “Initiated” 2308. The outbound wire status is updated to “Received” 2310 prior to sending to the financial institution's backend systems for processing 2312. The outbound wire status is updated to “Sent” 2314 after sending the wire transfer to the Fedwire system via a payment or transfer order.

The wire transfer is registered once it arrives in the Fedwire system 2316 and credit/debits are applied in the Fedwire settlement system 2318. Acknowledgement of financial institution A's receipt of funds is confirmed and the wire payment status is updated to “Received” 2320 by the Fedwire system via an API call to the WMT system 2306. The sending of a funds transfer order 2322 and related advice of the wire payment to financial institution B 2326 is accomplished by Fedwire 2316 while communicating with WMT system 2306 to update to the wire payment status to “Sent” 2324.

Financial institution B 2326 uses financial institution's wire transfer processing module 302 to update the inbound status 2328 of the wire transfer in WMT system 2306 to “Received” 2330. Financial institution B's 2326 receives an internal massage as an internal financial institution transfer 2334 for benefit of the receiver of the wired funds. Once the wired funds are ready to be sent outbound by wire transfer 2334 message 2336 is sent to the WMT system 2306 confirming transmission of the wired funds.

Financial institution B 2326 transmits the wire payment via SWIFT 2338 to financial institution C 2340 (e.g., beneficiary financial institution foreign location). Financial institution B 2326 communicates a “push” message to SWIFT 2338 and receives an “acknowledgement” from SWIFT 2338 of the wire transfer. Financial institution B 2326 uses its financial institution wire payment processing module 302 to update the status of the wire payment 2342 in the WMT system 2306 to “Received” 2344.

SWIFT sends an acknowledgement to financial institution B's payment providing feedback that the transfer to financial institution C 2340 is confirmed, and the wire payment status is updated to “Received” by the SWIFT system 2338 via an API call to the WMT system 2306. SWIFT 2338 signals financial institution C 2340 that it is facilitating a wire transfer payment and the wire payment status is updated to “Sent” 2348 via an API call to the WMT system 2306. Financial institution C 2340 (e.g., beneficiary financial institution foreign location) receives the wire payment transfer from SWIFT 2338 and processes the transaction. Financial institution C 2340 uses its financial institution wire payment processing module 302 to update the inbound process wire transfer 2350 status of the wire payment in a status message in the WMT system 2306 to “Received” 2352. Financial institution C (foreign) 2340 passes the wired funds to the send outbound wire transfer 2354 and the message “Received” 2356 is sent to the WMT system 2306. The inbound process wire transfer 2360 of financial institution D 2358 sends a “Received” message 2362 to the WMT system 2306.

FIG. 24 is a signal path diagram that illustrates the message flow according to the wiring of funds illustrated in FIG. 23. When a wire of funds is initiated 2400 at a first financial institution A 2300, the wire transfer instructions are passed 2400 within financial institution A 2300 from the wire initiated stage 2302 to the outbound wire transfer stage 2304. At approximately the same time, a message 2402 is sent from the financial institution A 2300 to the WMT system 2306. When the outbound process wire transfer 2304 passes 2404 the wire transfer to the send out bound wire transfer stage 2312, another message 2406 is sent to the WMT system 2306.

At this point, financial institution A 2300 sends 2408 the wired funds to Fedwire 2316, a message 2410 is sent by financial institution A 2400 to the WMT system 2306. Upon receipt of the wired funds at Fedwire 2316, a message 2412 is sent by Fedwire 2316 to the WMT system 2306 indicating that the wired funds 2408 have arrived 2318 at Fedwire 2316. Once Fedwire receives and processes the wire transfer 2318 the funds are internally prepared to be sent to the next financial institution. When the funds are ready to be sent 2414, Fedwire 2316 sends a message 2416 to the WMT system 2306.

The funds are then transferred 2418 from Fedwire 2316 to financial institution B 2326 located in the United States. When the funds arrive at financial institution B 2326, a message 2420 is sent to the WMT system 2306. The financial institution B 2326 then passes 2426 the wired funds to the send wire transfer position 2334 within financial institution B in the United States 2326.

Financial institution B 2326 then sends the wired funds 2428 to SWIFT 2338 where an acknowledgement 2430 is sent by SWIFT 2338 to financial institution B 2326 and a message 2432 is sent to the WMT system 2306. SWIFT 2338 then passes 2434 the wired funds from the received and process wire transfer 2342 to the send wire transfer 2346. The wired funds are then sent 2436 by SWIFT 2338 to financial institution C 2340.

SWIFT acknowledgement 2438 can be sent by financial institution C 2340 to SWIFT 2338. The recipient financial institution C 2340 may also be requested by SWIFT to send an acknowledgement represented by a “Long ACK” 2440 to financial institution B 2326. A WMT system 2306 message 2442 is sent from financial institution C (foreign) 2340 to WMT system 2306 indicating that the wired funds have arrived at financial institution C (foreign) 2340.

Financial institution C (foreign) 2340 then passes 2444 the wired funds to the outbound wire transfer 2354. The wired funds are then sent from financial institution C 2340 via 2446 to financial institution D 2340. A message 2448 is then sent by financial institution D 2340 to the WMT system 2306 indicating that the wired funds were “Received” by financial institution D 2340. Throughout the wire transfer process, the sender of the funds, the sender's financial institution 2302, the recipient, the recipient's financial institution C 2340 and any intermediary parties can log into the WMT system 2306 and review the wired funds progress. The SMT system 2906 is capable of operating independently of other third party messaging services so that the third party messaging service can continue to operate if desired by a financial institution.

FIG. 25 is a block diagram illustrating a wire of funds in the United Stated using SWIFT and interactions with the wire management and tracking system. FIG. 25 represents an example of message flow of the transmission of Unites States domestic wires utilizing the SWIFT settlement and transmission services with status updates. Financial institution A 2500 initiates a wire transfer 2502 of funds and starts the outbound wire transfer process 2504. The financial institution's wire transfer processing module 302 processes the wire transfer data with the primary code and communicates with the WMT system 2506 to register the primary code status update “Initiated” 2508. The outbound wire status is updated to “Received” 2510 prior to sending to the financial institution's backend systems for processing 2512. The outbound wire status is updated to “Sent” 2514 after sending the wire transfer to the SWIFT system via a payment or transfer order.

The wire transfer is registered once it arrives in the SWIFT system 2516 and credit/debits are applied in the SWIFT settlement system 2518. Acknowledgement of financial institution A's transfer of funds to financial institution B is confirmed 1720 and the wire payment status is updated to “Received” 2518 by the SWIFT system via an API call to the WMT system 2506. The sending of a funds transfer order 2522 and related advice of the wire payment to financial institution B 2526 is accomplished by SWIFT while communicating with WMT system 2506 to update to the wire payment status to “Sent” 2524. Financial institution B 2526 uses financial institution's wire transfer processing module 302 to update the inbound status 2528 of the wire transfer in WMT system 2506 to “Received” 2530.

FIG. 26 is a signal path diagram that illustrates the message flow according to the wiring of funds illustrated in FIG. 25. When a wire of funds is initiated 2600 at a first financial institution A 2500, the wire transfer instructions are passed within financial institution A 2500 from the wire initiated stage 2502 to the outbound wire transfer stage 2504. At approximately the same time, a message 2602 is sent from the financial institution A 2500 to the WMT system 2506. When the outbound process wire transfer 2504 passes 2604 the wire transfer to the send out bound wire transfer stage 2512, another message 2606 is sent to the WMT system 2506.

At this point, financial institution A 2500 sends 2608 the wired funds to SWIFT 2516, a message 2610 is sent by financial institution A 2500 to the WMT system 2506. Upon receipt of the wired funds at SWIFT 2516, a message 2612 is sent by SWIFT 2516 to the WMT system 2506 indicating that the wired funds 2608 have arrived 2518 at SWIFT 2516. Once SWIFT receives and processes the wire transfer 2518 the funds are internally prepared to be sent to the next financial institution. When the funds are ready to be sent 2614, SWIFT 2516 sends a message 2616 to the WMT system 2506. The funds are then transferred 2618 from SWIFT 2516 to financial institution B 2526. When the funds arrive at financial institution B 2526, a message 2620 is sent to the WMT system 2506 thus completing the wire transfer messaging. Throughout the wire transfer process, the sender of the funds, the sender's financial institution 2502, the recipient, the recipient's financial institution B 2526 and any intermediary parties can log into the WMT system 2506 and review the funds progress. The SMT system 2906 is capable of operating independently of other third party messaging services so that the third party messaging service can continue to operate if desired by a financial institution.

FIG. 27 is a block diagram that illustrates the messages sent using a wire management and tracking system during the transmission of a wire payment from a first financial institution to a second financial institution via SWIFT and onwards to a third financial institution via SWIFT. Financial institution A 2700 initiates a wire transfer 2702 of funds and starts the outbound wire transfer process 2704. The financial institution's wire transfer processing module 302 processes the wire transfer data with the primary code and communicates with the WMT system 2706 to register the primary code status update “Initiated” 2708. The outbound wire status is updated to “Received” 2710 prior to sending to the financial institution's backend systems for processing 2712. The outbound wire status is updated to “Sent” 2714 after sending the wire transfer to the SWIFT system via a payment or transfer order.

The wire transfer is registered once it arrives in the SWIFT system 2716 and credit/debits are applied in the SWIFT settlement system 2718. Acknowledgement of financial institution A's transfer of funds to financial institution B is confirmed and the wire payment status is updated to “Received” 2720 by the SWIFT system via an API call to the WMT system 2706. The sending of a funds transfer order 2722 and related advice of the wire payment to financial institution B 2726 is accomplished by SWIFT 2708 while communicating with WMT system 2706 to update to the wire payment status to “Sent” 2724. Financial institution B 2726 uses financial institution's wire transfer processing module 302 to update the inbound status 2728 of the wire transfer in WMT system 2706 to “Received” 2730. Financial institution B's 2726 (e.g., beneficiary financial institution) receives an internal massage as an internal financial institution transfer 2734 for benefit of the receiver of the wired funds. Once the wired funds are sent out from financial institution B 2726, a message 2736 is sent to the WMT system 2706 confirming transmission of the wired funds.

Financial institution B 2726 transmits the wire payment 2734 via SWIFT 2738 to financial institution C 2740 (e.g., beneficiary financial institution foreign location). Financial institution B 2726 communicates a “push” message to SWIFT 2738 and receives an “acknowledgement” from SWIFT 2738 of the wire transfer. Financial institution B 2726 uses its financial institution wire payment processing module 302 to update the status of the wire payment in the WMT system 2706 to “Sent” 2736.

SWIFT sends an acknowledgement to financial institution B providing feedback that the transfer to financial institution C 2740 is confirmed, and the wire payment status is updated to “Received” 2744 by the SWIFT system 2738 via an API call to the WMT system 2706. SWIFT 2738 signals via its send wire transfer 2746 to financial institution C 2740 that it is facilitating a wire transfer payment and the wire payment status is updated to “Sent” 2748 via an API call to the WMT system 2706. Financial institution C 2740 (e.g., beneficiary financial institution foreign location) receives the wire payment transfer from SWIFT 2738 and processes the transaction. Financial institution C 2740 uses its financial institution wire payment processing module 302 to update the inbound process wire transfer 2750 status of the wire payment in a status message in the WMT system 2706 to “Received” 2752.

FIG. 28 is a signal path diagram that illustrates the message flow according to the wiring of funds illustrated in FIG. 27. When a wire of funds is initiated 2800 at a first financial institution A 2700, the wire transfer instructions are passed 2800 within financial institution A 2700 from the wire initiated stage 2702 to the outbound wire transfer stage 2704. At approximately the same time, a message 2802 is sent from the financial institution A 2700 to the WMT system 2706. When the outbound process wire transfer 2704 passes 2804 the wire transfer to the send out bound wire transfer stage 2712, another message 2806 is sent to the WMT system 2706.

At this point, financial institution A 2700 sends 2808 the wired funds to SWIFT 2716, a message 2810 is sent by financial institution A 2800 to the WMT system 2706. Upon receipt of the wired funds at SWIFT 2716, a message 2812 is sent by SWIFT 2716 to the WMT system 2706 indicating that the wired funds 2808 have arrived 2718 at SWIFT 2716. Once SWIFT receives and processes the wire transfer 2718 the funds are internally prepared to be sent to the next financial institution. When the funds are ready to be sent 2814, SWIFT 2716 sends a message 2816 to the WMT system 2706.

The funds are then transferred 2818 from SWIFT 2716 to financial institution B 2726 located in the United States. When the funds arrive at financial institution B 2726, a message 2820 is sent to the WMT system 2706. The financial institution B 2726 then passes 2826 the wired funds to the send wire transfer position 2734 within financial institution B in the United States 2726.

Financial institution B 2726 then sends the wired funds 2828 to SWIFT 2738 where an acknowledgement 2830 is sent by SWIFT 2738 to financial institution B 2726 and a message 2832 is sent to the WMT system 2706. SWIFT 2738 then passes 2834 the wired funds from the received and process wire transfer 2742 to the send wire transfer 2746. The wired funds are then sent 2836 by SWIFT 2738 to financial institution C 2740. A SWIFT acknowledgement 2838 can be sent by financial institution C 2740 to SWIFT 2738. The recipient financial institution C 2740 may also be requested to send an acknowledgement represented by a “Long ACK” 2740 to financial institution B 2726. This is a SWIFT message 2842 from financial institution C (foreign) 2740 to WMT system 2706 indicating that the wired funds have arrived would be viewable and accessible to financial institution B 2726. Message 2842 and SWIFT messages 2838 and 2840 alert WMT system 2706 and various intermediary parties that the funds have arrived at their destination. Throughout the wire transfer process, the sender of the funds, the sender's financial institution 2702, the recipient, the recipient's financial institution C 2740 and any intermediary parties can log into the WMT system 2706 and review the wired funds progress. The SMT system 2906 is capable of operating independently of other third party messaging services so that the third party messaging service can continue to operate if desired by a financial institution.

FIG. 29 is a block diagram that illustrates the messages sent using a WMT system during the transmission of a wire payment to another country's financial institution using SWIFT to route the funds to a United States beneficiary financial institution and SWIFT to route the funds to a first foreign country's financial institution and then to a second financial institution in that foreign country. Financial institution A 2900 initiates a wire transfer 2902 of funds and starts the outbound wire transfer process 2904. The financial institution's wire transfer processing module 302 processes the wire transfer data with the primary code and communicates with the WMT system 2906 to register the primary code status update “Initiated” 2908. The outbound wire status is updated to “Received” 2910 prior to sending to the financial institution's backend systems for processing 2912. The outbound wire status is updated to “Sent” 2914 after sending the wire transfer to the SWIFT system via a payment or transfer order.

The wire transfer is registered once it arrives in the SWIFT system 2916 and credit/debits are applied in the SWIFT settlement system 2918. Acknowledgement of financial institution A's receipt of funds is confirmed and the wire payment status is updated to “Received” 2920 by the SWIFT system via an API call to the WMT system 2906. The sending of a funds transfer order 2922 and related advice of the wire payment to financial institution B 2926 is accomplished by SWIFT 2916 while communicating with WMT system 2906 to update to the wire payment status to “Sent” 2924.

Financial institution B 2926 uses financial institution's wire transfer processing module 302 to update the inbound status 2928 of the wire transfer in WMT system 2906 to “Received” 2930. Financial institution B's 2926 receives an internal massage as an internal financial institution transfer 2934 for benefit of the receiver of the wired funds. Once the wired funds are ready to be sent outbound by wire transfer 2934 message 2936 is sent to the WMT system 2906 confirming transmission of the wired funds.

Financial institution B 2926 transmits the wire payment via SWIFT 2938 to financial institution C 2940 (e.g., beneficiary financial institution foreign location). Financial institution B 2926 communicates a “push” message to SWIFT 2938 and receives an “acknowledgement” from SWIFT 2938 of the wire transfer. Financial institution B 2926 uses its financial institution wire payment processing module 302 to update the status of the wire payment 2942 in the WMT system 2906 to “Received” 2944.

SWIFT sends an acknowledgement to financial institution B's payment providing feedback that the transfer to financial institution C 2940 is confirmed, and the wire payment status is updated to “Received” by the SWIFT system 2938 via an API call to the WMT system 2906. SWIFT 2938 signals financial institution C 2940 that it is facilitating a wire transfer payment and the wire payment status is updated to “Sent” 2948 via an API call to the WMT system 2906. Financial institution C 2940 (e.g., beneficiary financial institution foreign location) receives the wire payment transfer from SWIFT 2938 and processes the transaction. Financial institution C 2940 uses its financial institution wire payment processing module 302 to update the inbound process wire transfer 2950 status of the wire payment in a status message in the WMT system 2906 to “Received” 2952. Financial institution C (foreign) 2940 passes the wired funds to the send outbound wire transfer 2954 and the message “Received” 2956 is sent to the WMT system 2906. The inbound process wire transfer 2960 of financial institution D 2958 sends a “Received” message 2962 to the WMT system 2906.

FIG. 30 is a signal path diagram that illustrates the message flow according to the wiring of funds illustrated in FIG. 29. When a wire of funds is initiated 3000 at a first financial institution A 2900, the wire transfer instructions are passed 3000 within financial institution A 2900 from the wire initiated stage 2902 to the outbound wire transfer stage 2904. At approximately the same time, a message 3002 is sent from the financial institution A 2900 to the WMT system 2906. When the outbound process wire transfer 2304 passes 3004 the wire transfer to the send out bound wire transfer stage 2912, another message 3006 is sent to the WMT system 2906.

At this point, financial institution A 2900 sends 3008 the wired funds to SWIFT 2916, a message 3010 is sent by financial institution A 3000 to the WMT system 2906. Upon receipt of the wired funds at SWIFT 2916, a message 3012 is sent by SWIFT 2916 to the WMT system 2906 indicating that the wired funds 3008 have arrived 2918 at SWIFT 2916. Once SWIFT receives and processes the wire transfer 2918 the funds are internally prepared to be sent to the next financial institution. When the funds are ready to be sent 3014, SWIFT 2916 sends a message 3016 to the WMT system 2906.

The funds are then transferred 3018 from SWIFT 2916 to financial institution B 2926 located in the United States. When the funds arrive at financial institution B 2926, a message 3020 is sent to the WMT system 2906. The financial institution B 2926 then passes 3026 the wired funds to the send wire transfer position 2934 within financial institution B in the United States 2926.

Financial institution B 2926 then sends the wired funds 3028 to SWIFT 2938 where an acknowledgement 3030 is sent by SWIFT 2938 to financial institution B 2926 and a message 3032 is sent to the WMT system 2906. SWIFT 2938 then passes 2434 the wired funds from the received and process wire transfer 2942 to the send wire transfer 2946. The wired funds are then sent 3036 by SWIFT 2938 to financial institution C 2940.

SWIFT acknowledgement 3038 can be sent by financial institution C 2940 to SWIFT 2338. The recipient financial institution C 2940 may also be requested by SWIFT to send an acknowledgement represented by a “Long ACK” 3040 to financial institution B 2926. A WMT system 2906 message 3042 is sent from financial institution C (foreign) 2940 to WMT system 2906 indicating that the wired funds have arrived at financial institution C (foreign) 2940.

Financial institution C (foreign) 2940 then passes 3044 the wired funds to the outbound wire transfer 2954. The wired funds are then sent from financial institution C 2940 via 3046 to financial institution D 2940. A message 3048 is then sent by financial institution D 2940 to the WMT system 2906. Throughout the wire transfer process, the sender of the funds, the sender's financial institution 2902, the recipient, the recipient's financial institution C 2940 and any intermediary parties can log into the WMT system 2906 and review the wired funds progress. The SMT system 2906 is capable of operating independently of other third party messaging services so that the third party messaging service can continue to operate if desired by a financial institution. Financial institution D 2940 uses financial institution wire payment processing module 302 to update the status of the wire payment in the WMT system 2906 to “Received” 3048.

FIG. 31 is a block diagram of an example implementation of the wire management and tracking system software 3100 that operates on a plurality of microprocessors. In this example, the wire management and tracking system software operates on a plurality of processing units 3100 that can access memory locations 3102 for storing data and further comprises components for use during operation of the software. The wire management and tracking system software contains a controller or a computing device that further includes one or more processing units 3100, one or more memory storage locations 3102 for storing software and/or firmware code as well as data generated by the wire management and tracking system software's operation, a computer-readable medium 3104, and one or more communication or network interfaces 3106. In this example, the one or more processing units 3100, one or more memory units 3102, computer-readable medium 3104, and one or more communication interfaces 3106 are in signal communication and operatively connected with each other via a bus signal path 3108 which may include one or more system buses such as a data bus, an address bus, a PCI bus, a Mini-PCI bus, and any variety of local, peripheral, and/or independent buses.

The computer-readable medium 3104 includes encoded computer-executable instructions that cause the one or more processing units 3100 to generate a data store 3110 from the data collected 3112 from sensors, other computer-readable medium components and user input, thus generating control output signals based on the collected data 3112 and session data 3116 and/or operational data 3114.

A computer readable signal medium may also include a propagated data signal with computer readable program code embodied in the software, for example, as used in baseband signal or as part of a carrier wave. Such a propagated signal may take any of a variety of forms, including, but not limited to electro-magnetic, optical, or any suitable combinations. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of these technologies.

Computer program code for carrying out operations for aspects of this invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer, for example, through the Internet using an Internet Service Provider.

As utilized, the one or more processing units 3100 may represent, for example, a CPU-type processing unit, a GPU-type processing unit, a field-programmable gate array (“FPGA”), digital signal processor(s) (“DSP”), or other hardware logic components that may, in some instances, be driven by a central processing unit (“CPU”). For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

The computer-readable medium 3104 may store instructions executable by the one or more processing units 3100. The computer-readable medium 3104 may also store instructions executable by external processing units (not shown) such as by an external CPU, an external GPU, and/or executable by an external accelerator, such as an FPGA type accelerator, a DSP type accelerator, or any other internal or external accelerator. In some embodiments, at least one CPU, GPU, and/or accelerator are incorporated in the computing device, while in other embodiments, one or more of a CPU, GPU, and/or accelerator may be external to the computing device.

The computer-readable medium 3104 may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media may include tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to the computer storage medium 3110, communication media may embody computer-readable instructions, data structures, program modules, or other data in a modulated data signal, such as a carrier wave, or other transmission mechanism.

The one or more communication interfaces 3106 may represent, for example, transceiver devices to send and receive communications over a network. In this example, the computer-readable medium 3104 includes a data store 3110. In some examples, the data store 3110 may include data storage such as a database, data warehouse, or other type of structured or unstructured data storage for operation of computing device.

The data store 3110 may store data for the operation of processes, applications, components, and/or modules stored in computer-readable medium 3104, such as the purchasing system and/or executed by the one or more processing units 3100 and/or accelerator(s). As an example, the data store 3110 may store operational data relating to the operation of the wire management and tracking system 3114, session data such as data related to specific wire transfer transactions and related information data on the specific wire transaction 3116 and/or other collected data 3112 that may be useful for analytics.

Alternately, some or all of the above-referenced data may be stored on the separate one or more memory units 3102 on board the one or more processing units 3100 such as, for example, a memory on board a CPU-type processor, a GPU-type processor, an FPGA-type accelerator, a DSP-type accelerator, and/or another accelerator. In this example, the computer-readable medium 3104 also includes an operating system 3118 and application programming interfaces (“APIs”) 3120 configured to expose the functionality and the data generated by the operation of the purchasing system to external devices associated with the computing device via the one or more communication interfaces 3108.

Additionally the computer-readable medium 3104 may include one or more modules such as the server module 3122, input module (not shown), and output module 3124, although the number of illustrated modules is just an example, and the number may vary higher or lower. The server module 3122 can act as a longer term storage medium for data collected by the purchasing system. A wireless interface can connect the purchasing system to a cloud based server system where operational, session and environmental data is stored. In another embodiment, a wired interface can connect with the wire management and tracking system software during battery recharging of mobile devices such that the data stored in memory on the mobile devices is periodically uploaded and backed up to WMT system′ cloud based server system.

That is, the functionality described in this disclosure in association with the illustrated modules in the computing device may be performed by a fewer number of modules or a larger number of modules on one device or spread across multiple devices. In this example, the output module 3124 may be in signal communication with one or more output devices such as, for example, one or more displays, sound generating loud speakers or one or more mobile devices that allow the mobile device to transmit data. Similarly, the input module may be in signal communication with one or more input devices such as, for example, a virtual or actual keyboard, mouse or joy stick controller, general pointing device, or a touch screen that accepts input commands from the customer's mobile device to respond to and input commands to the wire management and tracking system software.

In some embodiments, the wire management and tracking system may be performed and implemented based on input of software instructions executed on at least one microprocessor such as on the computer system is illustrated by FIG. 32. Accordingly, in FIG. 32 a computer system that may form a network from a plurality of computer systems may be used to implement the wire management and tracking system. Computer system 3200 may be implemented at each node wire management and tracking system including the financial institutions' servers and the customers' computer access devices such as smartphones, pads, laptops and desktops, etc.

The computer system 3200 may include one or more processors or processor cores 3202 that are connected to and interface with a system memory 3204 via an input/output (I/O) interface 3206. The computer system 3200 further includes a network interface 3208 coupled to I/O interface 3206 and connected to a wired or wireless network connection 3210. Also connected to the input/output device 3206 may be one or more input/output devices 3212, such as keyboard 3214, display(s) 3216, cursor control device 3218, a scanner 3220, audio device (not shown), analog and/or digital sensors 3222 and/or some other device. In some embodiments, it may be contemplated that the wire management and tracking system is implemented using a single instance of a computer system 3200, while in most other embodiments, multiple computer systems 3200 may be included, or multiple nodes making up the computer system 3200, may be configured to host different portions or instances of the embodiments. For example, in one embodiment some elements may be implemented via one or more nodes of computer system 3200 that are distinct from those nodes implementing other elements.

In some embodiments, the computer system 3200 may be a uniprocessor system including only one processor 3202 or processor core, or a multiprocessor system including a plurality of processors or processor cores 3202. Processors 3202 may be any suitable processor capable of executing instructions. For example, in some embodiments, processor(s) 3202 may be general-purpose or embedded processors implementing any of a variety of instruction set architectures (ISAs), such as the x86 (e.g., x86, x86-32, x86-64, and subsequent generations), PowerPC or Power ISA architectures, Reduced Instruction Set Computer (“RISC”), Complex Instruction Set Computer (“CISC”), Scalable Processor Architecture (“SPARC”), or Microprocessor without Interlocked Pipeline Stages (“MIPS”) architecture, or any other suitable ISA, including derivative versions of this list or new architectures that may displace this list. In multiprocessor systems, each of the processors 3202 may commonly, but not necessarily, implement the same ISA.

System memory 3204 may be configured to store program instructions and/or data accessible by the processor(s) 3210. In some embodiments, the system memory 3204 may be implemented using any suitable memory technology, such as static random access memory (SRAM), synchronous dynamic RAM (SDRAM), nonvolatile/flash-type memory, phase change, or any other type of memory. In the illustrated embodiment, program instructions and data implementing desired functions, such as those described for providing a wire management and tracking system may be stored within the system memory 3204, as program instructions 3224 and data storage 3226, respectively. In other embodiments, the program instructions and/or data may be received, sent or stored upon different types of computer-accessible media or on similar media separate from system memory 3204 or the computer system 3200. Generally speaking, a computer-accessible medium may include storage media or memory media such as magnetic or optical media, e.g., optical disks such as CDs, DVD-ROM or other variants coupled to the computer system 3200 via the I/O interface 3206. The program instructions and data stored via a computer-accessible medium may be transmitted by transmission media or signals such as electrical, electromagnetic, optical or digital signals, which may be conveyed via a communication medium such as a network and/or a wired or wireless link, such as may be implemented via network interface 3208.

In one embodiment, the I/O interface 3206 may be configured to coordinate I/O traffic between the processor(s) 3202, the system memory 3204, and any peripheral devices including network interface 3208 or other peripheral interfaces, such as the input/output devices 3212. In other embodiments, the I/O interface 3206 may perform any necessary protocol, timing or other data transformations to convert data signals from one component (e.g., system memory 3204) into a format suitable for use by another component (e.g., processor 3202). In still other embodiments, the I/O interface 3206 may include support for devices attached through some types of peripheral buses, such as a variant of the Peripheral Component Interconnect (“PCI”) bus standard, the Universal Serial Bus (“USB”) standard, or any other similar peripheral bus standard. In some embodiments, the function of the I/O interface 3206 may be split into two or more separate components, such as a north bridge and a south bridge. In addition, in some embodiments some or all of the functionality of the I/O interface 3206, such as an interface to system memory 3204, may be incorporated directly into the processor(s) 3202.

The network interface 3208 may be configured to allow data to be exchanged between the computer system 3200 and other devices attached to a network, such as other computer systems, or between nodes of computer system 3200. In some embodiments, the network interface 3208 may support communication via wired or wireless general data networks, such as any suitable type of Ethernet network, via telecommunications/telephony networks such as analog voice networks or digital fiber communications networks; via storage area networks such as fibre channel SANs, or via any other suitable type of network and/or protocol.

Input/output devices 3212 may, in some embodiments, include one or more display terminals, keyboards, keypads, touchpads, scanning devices, voice or optical recognition devices, analog or digital sensors 3222 or any other devices suitable for entering or retrieving data by one or more computer system 3200. Multiple input/output devices 3212 may be present in the computer system 3200 or may be distributed on some nodes of the computer system 3200. In some embodiments, similar input/output devices may be separate from the computer system 3200 and may interact with one or more nodes of the computer system 3200 through a wired or wireless connection, such as over a network interface 3208.

As shown in FIG. 32, the memory 3204 may include program instructions 3224, configured to implement embodiments providing a wire management and tracking system and related data storage 3226, comprising various data accessible by the program instructions 3224. In one embodiment, the program instructions 3224 may include software elements for providing the wire management and tracking system. The data storage 3226 may include data that may be used in some of the embodiments while in other embodiments the different software elements and data may be included.

To those skilled in the art will appreciate that computer system 3200 is merely illustrative and is not intended to limit the scope of a software methodology for providing a wire management and tracking system. In particular, the computer system 3200 and the Input/Output devices 3212 may include any combination of hardware or software that can perform the indicated functions, including computers, network devices, internet appliances, PDAs, wireless phones, pagers, etc. The computer system 3200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while some items are illustrated as being stored in memory or in storage while being used, these items or portions of them may be transferred between memory and other storage devices for purposes of memory management and data integrity. Alternatively, in other embodiments some or all of the software components may execute in memory on another device and communicate with the illustrated computer system 3200 via inter-computer communication. Some or all of the system components or data structures may also be stored (e.g., as instructions or structured data) on a computer-accessible medium or a portable article to be read by an appropriate drive. In some embodiments, instructions stored on a computer-accessible medium separate from computer system 3200 may be transmitted to the computer system 3200 via transmission media or signals such as electrical, electromagnetic, or digital signals, conveyed via a communication medium such as a network wired and/or wireless link. Some embodiments may further include receiving, sending or storing instructions and/or data implemented in accordance with the foregoing description upon a computer-accessible medium. Accordingly, the invention may be practiced with other computer system configurations, including derivatives of future systems to the ones described here.

While various embodiments of the invention have been described, it will be apparent to those of ordinary skill in the art that many more embodiments and implementations are possible that are within the scope of this invention.

1. (canceled)

2. A method of creating a wire transfer tracking code for use in transferring funds from a sending party's account to a receiving party's account, comprising the steps of:
creating a first identification code from data identifying the receiving party and the receiving party's institution;
creating a second identification code from data identifying the receiving party's account number and the routing number for the receiving party's institution;
creating a third identification code from data representing an amount of the funds transmitted; and
creating a wire tracking code from the first identification code, the second identification code and the third identification code.

3. A method of transferring funds from a sending party's account to a receiving party's account, comprising the steps of:
obtaining flight path data describing a pathway for movement of the funds from a sending institution to a receiving institution;
creating a first identification code from data identifying the receiving party and the receiving party's institution;
creating a second identification code from data identifying the receiving party's account number and the routing number for the receiving party's institution;
creating a third identification code from data representing an amount of the funds transmitted; and
creating a wire tracking code from the first identification code, the second identification code and the third identification code.

4. The method of transferring funds from a sending party's account to a receiving party's account of claim 3, further comprising the stop of generating status messages for transmitting to at least one recipient regarding the location of the funds during the transfer from the sending party's account to the receiving party's account.

5. The method of transferring funds from a sending party's account to a receiving party's account of claim 4, where the recipient is the sending party's institution.

6. The method of transferring funds from a sending party's account to a receiving party's account of claim 4, where the recipient is the receiving party's institution.

7. The method of transferring funds from a sending party's account to a receiving party's account of claim 4, where the recipient is an intermediary institution.

8. The method of transferring funds from a sending party's account to a receiving party's account of claim 3, further including the step of transmitting remittance information from the sending party's institution to the receiving party's institution.

9. The method of transferring funds from a sending party's account to a receiving party's account of claim 3, further including the step of creating an analytic analysis on the funds travel along the flight path from the sending party's institution to the receiving party's institution.

10. The method of transferring funds from a sending party's account to a receiving party's account of claim 3, where the step of creating an analytics analysis further calculating an average processing time of wire transfers between a first and a second institution.

11. The method of transferring funds from a sending party's account to a receiving party's account of claim 10, where the step of creating an analytics analysis further calculating alternative flight paths based on the average processing time.

12. The method of transferring funds from a sending party's account to a receiving party's account of claim 10, where the step of creating an analytics analysis further identifying inefficiencies impacting flow of funds along the flight path.

13. The method of transferring funds from a sending party's account to a receiving party's account of claim 3, further including the step of calculating transaction fees of the funds along the flight path from the sending party's institution to the receiving party's institution.

14. The method of transferring funds from a sending party's account to a receiving party's account of claim 3, further including the step of calculating transaction fees of the funds along the flight path from the sending party's institution to the receiving party's institution.

15. The method of transferring funds from a sending party's account to a receiving party's account of claim 3, further including the step of transmitting foreign exchange rates from the sending party's institution to the receiving party's institution.

16. The method of transferring funds from a sending party's account to a receiving party's account of claim 3, further including the step of using a blockchain ledger to record the funds transfer.

17. The method of transferring funds from a sending party's account to a receiving party's account of claim 13, further including the step of inserting wire tracking number into the blockchain ledger.

18. A method of transferring funds from a sending party's account to a receiving party's account, comprising the steps of:
obtaining flight path data describing a pathway for movement of the funds from a sending institution to a receiving institution;
obtaining a first identification code from data identifying the receiving party and the receiving party's institution;
obtaining a second identification code from data identifying the receiving party's account number and the routing number for the receiving party's institution;
obtaining a third identification code from data representing an amount of the funds transmitted; and
pre-populating data fields for the transfer of funds using data from at least one identification code.

19. The method of transferring funds from a sending party's account to a receiving party's account of claim 18, where the at least one identification code is the first identification code.

20. The method of transferring funds from a sending party's account to a receiving party's account of claim 18, where the at least one identification code is the second identification code.

21. The method of transferring funds from a sending party's account to a receiving party's account of claim 18, where the at least one identification code is the first and the second identification codes.

22. The method of transferring funds from a sending party's account to a receiving party's account of claim 18, further including the step of transmitting remittance information from the sending party's institution to the receiving party's institution.

23. The method of transferring funds from a sending party's account to a receiving party's account of claim 18, further including the step of transmitting foreign exchange rates from the sending party's institution to the receiving party's institution.

24. The method of transferring funds from a sending party's account to a receiving party's account of claim 18, further including the step of using a blockchain ledger to record the funds transfer.

25. A method of initiating a transfer of funds by a receiving party from a sending party's account, comprising the steps of:
obtaining by receiver institution flight path data for the transfer of funds from a sending institution to the receiver institution;
obtaining by the receiver institution a first identification code comprising data identifying the sending party and the sending party's institution;
obtaining by the receiver institution a second identification code from data identifying the sending party's account number and the routing number for the sending party's institution;
obtaining by the receiver institution a third identification code from data representing an amount of the funds transmitted; and
transmitting the first, second and third identification codes to the sending institution for approval of the transfer of funds.

26. The method of initiating a transfer of funds by a receiving party from a sending party's account of claim 25, further including the step of transmitting remittance information from the receiving party's institution to the sending party's institution.

27. The method of initiating a transfer of funds by a receiving party from a sending party's account of claim 25, further including the step of transmitting foreign exchange rates from the receiving party's institution to the sending party's institution.

28. The method of initiating a transfer of funds by a receiving party from a sending party's account of claim 25, further including the step of using a blockchain ledger by the receiver institution to record the funds transfer.

29. A method of transferring funds from a sending party account to a receiving party account, comprising the steps of:
obtaining flight path data from a third party that describes a pathway for movement of the funds from a sending institution to a receiving institution;
creating a first identification code from data identifying the receiving party and the receiving party institution;
creating a second identification code from data identifying the receiving party account number and the routing number for the receiving party's institution;
creating a third identification code from data representing an amount of the funds transmitted; and
creating a wire tracking code from the first identification code, the second identification code and the third identification code.
